(19) United States
(12) Patent Application Publication
(10) Pub. No.: US 2026/0365857 A1
(43) Pub. Date: Nov. 19, 2026

(54) Carbon Blacks Having Strontium and/or Barium Additives and Methods to Make Same

(71) Applicant: Cabot Corporation, Boston, MA (US)

(72) Inventors: Bruce E. Mackay, Framingham, MA (US); William C. Holler, Ayer, MA (US); James Winter, Almeria (ES)

(21) Appl. No.: 19/142,415

(22) PCT Filed: Jan. 22, 2024
(86) PCT No.: PCT/US2024/012308

§ 371 Date: Jun. 23, 2025

Related U.S. Application Data
(60) Provisional application No. 63/481,435, filed on Jan. 25, 2023.

(51) Int. Cl. C09C 1/50; H01M 4/62

(52) U.S. Cl. CPC C09C 1/50; H01M 4/625; C01P 2006/12

(57) ABSTRACT

The present invention, in part, relates to a method to make carbon blacks utilizing at least feedstock additive that is or includes strontium, barium, or a combination thereof. Optional additional feedstock additives can be used in combination with the strontium and/or barium. The present invention further relates to a carbon black produced by one or more methods of the present invention. The present invention also relates to a carbon black carbon black having a nitrogen BET surface area (N2SA) of from 800 m²/g to 2,500 m²/g and concentration (ppm) of Group IIA elements in the carbon black that is less than or equal to 4.3*N2SA−2150, wherein the additive is or includes strontium, barium, or a combination thereof. Formulations, articles, and devices containing the carbon black are also disclosed.

### SUMMARY OF THE INVENTION

The present invention relates to carbon blacks and to methods of making the same. More specifically, the present invention relates to carbon blacks having or including strontium and/or barium additives. Further, the present invention relates to carbon blacks, such as etched carbon blacks, that contain strontium and/or barium along with optionally, one or more other additives.

The present innovation is based in part on a presently recognized need to develop a class of carbon blacks that can be made utilizing a lower overall combustion (OAC). Overall combustion is defined as the percentage of oxygen added to the entire reactor compared to the total amount of oxygen required to stoichiometrically react with all the fuel streams added to the entire reactor. By reducing the OAC and yet producing the same or essentially the same carbon black (based on parameters such as nitrogen surface area and/or COAN), a safer operation of the process of making carbon black can be achieved and/or a more environmentally-friendly operation of making carbon black can be achieved and/or a more reactor-friendly operation of making the carbon black can be achieved.

The present invention is also based in part on an improved substitute to calcium as an additive to feedstocks for such purposes as etching of the carbon black during formation. U.S. Pat. No. 8,895,142 discloses the use of calcium as an additive, especially when etching is desired in carbon black manufacturing. One problem with calcium is that it takes high ppm amounts, high OAC, or both to achieve the desired effect.

Thus, the present invention provides a way to obtain and/or addresses the above-defined problems and achieve the goals and advantages described herein.

More specifically, a feature of the present invention is to provide a carbon black that has particular surface area using a high OAC but utilizing less feedstock additive.

Another feature of the present invention is to provide a carbon black having a higher surface area that is produced at a given OAC and with less feedstock additive.

Yet another feature of the present invention is to provide a carbon black having a particular surface area but produced utilizing a lower OAC for a given amount of feedstock addition, with less feedstock additive for a given OAC, or with both lower OAC and less feedstock additive.

A further feature of the present invention is to provide a feedstock additive that can at least partially or fully replace calcium as a feedstock additive.

An additional feature of the present invention is to provide a feedstock additive that can not only replace calcium but provide one or more beneficial properties, including but not limited to, using less to achieve the same effect in carbon black, and/or requiring a lower OAC to achieve the same or similar effects in the carbon black produced, and/or producing lower ash contents.

Another feature of the present invention is to provide methods to produce carbon blacks utilizing certain feedstock additive(s) and certain OACs and reactor configurations based on desired surface area and OAC to achieve carbon blacks useful in one or more end uses, such as the reinforcement areas and/or in polymer conductive formulations.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a method for producing carbon black. The method includes introducing a heated gas stream into a carbon black reactor. The method further includes combining at least one feedstock additive with at least one carbon black feedstock to form a feedstock mixture. In this method, the feedstock additive(s) is or includes strontium or barium or a combination thereof. Other optional one or more feedstock additives can further be utilized. The method also includes supplying the feedstock mixture to at least one feedstock introduction point of the carbon black reactor and combining at least the feedstock mixture through the at least one introduction point to the carbon black reactor with the heated gas stream to form a reaction stream in which carbon black is formed. The carbon black formed has a nitrogen BET surface area of from 800 m²/g to 2,500 m²/g. The method then involves recovering the carbon black in the reaction stream. In the method, the method includes operating the carbon black reactor at an overall combustion (OAC) of from 28% to 50%. Further, in the method, the carbon black reactor is configured such that the OAC≤[(1350+N2SA−244*ln (additive ppm+1))/0.003]\hat{ }(1/3.5). The N2SA is nitrogen BET surface area measured as described below. The “additive ppm” is the total ppm amount (weight ppm) of metallic elements added to the feedstock excluding residual impurities in the feedstock additive.

The present invention further relates to a method for producing carbon black that includes introducing a heated gas stream into a carbon black reactor and supplying at least one carbon black feedstock to at least one feedstock introduction point to the carbon black reactor. The method also includes supplying at least one feedstock additive to at least one introduction point to the carbon black reactor. Again, here, the feedstock additive(s) is or includes strontium or barium or a combination thereof. Other optional one or more feedstock additives can further be utilized. The method also includes combining the at least one carbon black feedstock and the at least one feedstock additive, with the heated gas stream to form a reaction stream in which carbon black is formed having a nitrogen BET surface area of from 800 m²/g to 2,500 m²/g, in the carbon black reactor. The method then includes recovering the carbon black in the reaction stream. In this method, as in the other method, the method involves operating the carbon black reactor at an overall combustion (OAC) of from 28% to 50%. Further, the carbon black reactor is configured such that the OAC≤[(1350+N2SA−244*ln (additive ppm+1))/0.003]\hat{ }(1/3.5). The N2SA is nitrogen BET surface area measured as described below. The “additive ppm” is the total ppm amount (weight ppm) of metallic elements added to the feedstock excluding residual impurities in the feedstock additive.

In addition, the present invention relates to a carbon black having a nitrogen BET surface area (N2SA) of from 800 m²/g to 2,500 m²/g and a Group IIA concentration (ppm) that is <4.3*N2SA−2150. The Group IIA concentration includes at least strontium, or barium, or a combination thereof. The carbon black further optionally has an ash (%) this is ≤0.0012*N2SA−0.24. The N2SA is nitrogen BET surface area measured as described below. The Group IIA concentration is in ppm and is the total ppm amount (weight ppm) of all Group IIA elements present in the carbon black, and includes at least barium and/or strontium. The ash % is measured per ASTM D1506.

Unless stated otherwise, ppm amounts described herein are weight ppms.

It is to be understood that both the foregoing general description and the following detailed description are exemplary and explanatory only and are intended to provide a further explanation of the present invention, as claimed.

The accompanying drawings, which are incorporated in and constitute a part of this application, illustrate some of the embodiments of the present invention and together with the description, serve to explain the principles of the present invention.

### BRIEF DESCRIPTION OF DRAWINGS

FIGS. 1A and 1B are graphs showing nitrogen BET surface area as related to OAC for examples of the present carbon blacks (utilizing Sr (open symbols), Ba (closed symbols), or Sr—Ca blends (stippled triangles) feedstock additives) and comparison carbon blacks (utilizing only Ca as the feedstock additive, stippled circles and diamonds) at various concentrations in the feedstock (squares—250 ppm, triangles—700 ppm, circles—1000 ppm, diamonds—1500 ppm).

FIGS. 1A and 1B further show a series of equation lines (striped symbols: squares—250 ppm, triangles—700 ppm, circles—1000 ppm, diamonds—1500 ppm) that delineate the present furnace operating conditions and resulting nitrogen surface area from those for the comparison carbon blacks.

FIG. 2 is a schematic view of a portion of one type of carbon black reactor, which may be used to produce the present carbon blacks.

FIG. 3 is a graph showing Group IIA element concentration as related to nitrogen BET surface area for examples of the present carbon blacks (produced with a Sr or Ba feedstock additive, solid symbols) and comparison carbon blacks (produced with only a Ca feedstock additive, hollow symbols). FIG. 3 further shows an equation line that delineates the present carbon black properties from the comparison carbon blacks.

FIG. 4 is a graph showing ash (wt %) as related to nitrogen BET surface area for examples of the present carbon blacks (produced with a Sr or Ba feedstock additive, solid symbols) and comparison carbon blacks (produced with only a Ca feedstock additive, hollow symbols). FIG. 4 further shows an equation line that delineates the present carbon black properties from the comparison carbon blacks.

### DETAILED DESCRIPTION

Novel and unique methods to produce carbon blacks utilizing one or more certain feedstock additives is provided. Carbon blacks made from one or more of these methods is further provided. The carbon blacks produced include one or unique properties or relationships.

The nitrogen BET surface area is measured according to ASTM Standard D6556 with samples outgassed at 300 °C for one hour under nitrogen flow and measurements made over the nitrogen partial pressure range 0.05-0.1 P/Pₒ.

Regarding the methods of the present invention, the methods involve utilizing a feedstock additive that is or includes strontium, or that is or includes barium, or that is or includes a combination of strontium and barium (which can be introduced as a pre-blended mixture or can be introduced separately). Additional, but optional, other feedstock additives, such as calcium, can be used.

In more detail, in one method of the present invention, the method for producing the carbon black comprises, consists of, or includes introducing a heated gas stream into a carbon black reactor.

The method comprises, consists of, or includes combining at least one feedstock additive with at least one carbon black feedstock to form a feedstock mixture. The at least one feedstock additive is or includes or comprises strontium or barium or a combination thereof.

The method comprises, consists of, or includes supplying the feedstock mixture to at least one feedstock introduction point of the carbon black reactor.

The method comprises, consists of, or includes combining at least the feedstock mixture through the at least one introduction point to the carbon black reactor with the heated gas stream to form a reaction stream in which carbon black is formed having a nitrogen surface area of from 800 m²/g to 2,500 m²/g, in the carbon black reactor.

The method comprises, consists of, or includes recovering the carbon black in the reaction stream.

The method comprises, consists of, or includes operating the carbon black reactor at an overall combustion (OAC) of from 28% to 50%, for example, from 33.5% to 46.5%, and the carbon black reactor is configured such that OAC≤[(1350+N2SA−244*ln (additive ppm+1))/0.003]\hat{ }(1/3.5), wherein the additive comprises strontium, barium, or both, for example, from 50 to 1500 ppm strontium, barium or both as a fraction with respect to the total amount of feedstock. The N2SA is nitrogen BET surface area measured as described above. The “additive ppm” is the total ppm amount (weight ppm) of metallic elements added to the feedstock, excluding residual impurities in the feedstock additive.

In another method, the method for producing the carbon black comprises, consists of, or includes introducing a heated gas stream into a carbon black reactor.

The method comprises, consists of, or includes supplying at least one carbon black feedstock to at least one feedstock introduction point to the carbon black reactor.

The method comprises, consists of, or includes supplying (e.g., separately from the carbon black feedstock) at least one feedstock additive to at least one introduction point to the carbon black reactor. As before, the at least one feedstock additive is or includes or comprises strontium or barium or a combination thereof.

The at least one feedstock introduction point and the at least one introduction point can be the same or different, can be located at the same, about the same, or at different locations, or can overlap at one or more points if desired.

The method comprises, consists of, or includes combining the at least one carbon black feedstock and the at least one feedstock additive, with the heated gas stream to form a reaction stream in which carbon black is formed having a nitrogen surface area of from 800 m²/g to 2,500 m²/g, in the carbon black reactor. The nitrogen surface area is measured as described above.

The method comprises, consists of, or includes recovering the carbon black in the reaction stream.

The method comprises, consists of, or includes operating the carbon black reactor at an overall combustion (OAC) of from 28% to 50%, and the carbon black reactor is configured such that OAC≤[(1350+N2SA−244*ln (additive ppm+1))/0.003]\hat{ }(1/3.5), wherein the additive includes strontium, barium, or both. OAC is as defined earlier. The N2SA is nitrogen BET surface area of the resulting carbon black formed in the carbon black reactor. The “additive ppm” is the total ppm amount (weight ppm) of metallic elements added to the feedstock excluding residual impurities in the feedstock additive with respect to the total amount of feedstock.

Unless stated otherwise, any details or options described herein can be utilized in any of the methods of the present invention.

Regarding the nitrogen surface area (i.e., nitrogen BET surface area or N2SA) that can be achieved with the methods of the present invention, the N2SA can be from 800 m²/g to 2,500 m²/g, such as from 900 m²/g to 2,400 m²/g, or from 850 m²/g to 2,400 m²/g, or from 825 m²/g to 2,500 m²/g, or from 850 m²/g to 2,500 m²/g, or from 875 m²/g to 2,500 m²/g, or from 900 m²/g to 2,500 m²/g, or from 925 m²/g to 2,500 m²/g, or from 950 m²/g to 2,500 m²/g, or from 1,000 m²/g to 2,500 m²/g, or from 1,100 m²/g to 2,500 m²/g, or from 1,200 m²/g to 2,500 m²/g, or from 1,250 m²/g to 2,500 m²/g, or from 1,300 m²/g to 2,500 m²/g, or from 800 m²/g to 2,450 m²/g, or from 800 m²/g to 2,400 m²/g, or from 800 m²/g to 2,350 m²/g, or from 800 m²/g to 2,300 m²/g, or from 800 m²/g to 2,250 m²/g, or from 800 m²/g to 2,200 m²/g, or from 800 m²/g to 2,150 m²/g, or from 800 m²/g to 2,100 m²/g, or from 800 m²/g to 2,050 m²/g, or from 800 m²/g to 2,000 m²/g, or from 800 m²/g to 1,950 m²/g, or from 800 m²/g to 1,900 m²/g, or from 800 m²/g to 1,800 m²/g, or from 800 m²/g to 1,700 m²/g, or any N2SA that is below or above any of these ranges or any combination of one end point of one range with another end point of a second range.

In the methods of the present invention, the carbon black reactor is configured to or is operated at an overall combustion (OAC) of from 28% to 50%. The OAC can be from 28.5% to 50%, or from 29% to 50%, or from 29.5% to 50%, or from 30% to 50%, or from 30.5% to 50%, or from 31% to 50%, or from 31.5% to 50%, or from 32% to 50%, or from 32.5% to 50%, or from 33% to 50%, or from 33.5% to 50%, or from 34% to 50%, or from 34.5% to 50%, or from 35% to 50%, or from 35.5% to 50%, or from 36% to 50%, or from 36.5 to 50%, or from 37% to 50%, or from 37.5% to 50%, or from 38% to 50%, or from 38.5% to 50%, or from 39% to 50%, or from 39.5% to 50%, or from 40% to 50%, or from 41% to 50%, or from 42% to 50%, or from 45% to 50%, or from 28% to 49.5%, or from 28% to 49%, or from 28% to 48.5%, or from 28% to 48%, or from 28% to 47.5%, or from 28% to 47%, or from 28% to 46.5%, or from 33.5% to 47%, or from 33.5% to 46.5%, or from 33.5% to 46%, or from 33% to 47%, or from 28% to 46%, or from 28% to 45.5%, or from 28% to 45%, or from 28% to 44%, or from 28% to 43%, or from 28% to 43%, or from 28% to 42%, or from 28% to 41%, or from 28% to 40%, or from 28% to 38%, or from 28% to 36%, or from 28% to 34%, or from 28% to 32%, or other OACs above or below any one of these ranges or any combination of one end point of one range with another end point of a second range.

As indicated, the carbon black reactor is configured such that OAC≤[(1350+N2SA−244*ln (additive ppm+1))/0.003]\hat{ }(1/3.5) [Equation 1]. The carbon black reactor can be configured such that OAC< [(1350+N2SA−244*ln (additive ppm+1))/0.003]\hat{ }(1/3.5).

Referring to Equation 1, the OAC can be at least 1% less than the number resulting from Equation 1 or can be at least 2% less, 3% less, 5% less, 7% less, 10% less, 15% less, 20% less, or 25% less, such as from 1% to 25% less than the number resulting from Equation 1. And, these amounts of OAC can be in combination with the N2SA of from 800 m²/g to 2,500 m²/g, or from 900 m²/g to 2,400 m²/g, or from 1000 m²/g to 2,300 m²/g, or from 1100 m²/g to 2,300 m²/g or any of the other N2SA numbers or ranges provided herein.

As further examples, in the methods, the OAC can be from 33% to 47% and the N2SA can be from 900 m²/g to 2,400 m²/g.

As another example, the OAC can be from 33.5% to 46.5% and the N2SA can be from 850 m²/g to 2,400 m²/g.

As another example, the OAC can be from 33.5% to 46.5% and the N2SA can be from 1000 m²/g to 2,400 m²/g.

The OAC can be controlled in a number of ways. For instance, the OAC can be controlled, at least in part, by controlling the amount of feedstock introduced in the carbon black reactor. Other ways to control the OAC include, but are not limited to, controlling the amount and composition of heated gas introduced to the carbon black reactor and/or changing the composition of feedstock (such as hydrogen to carbon mass ratio).

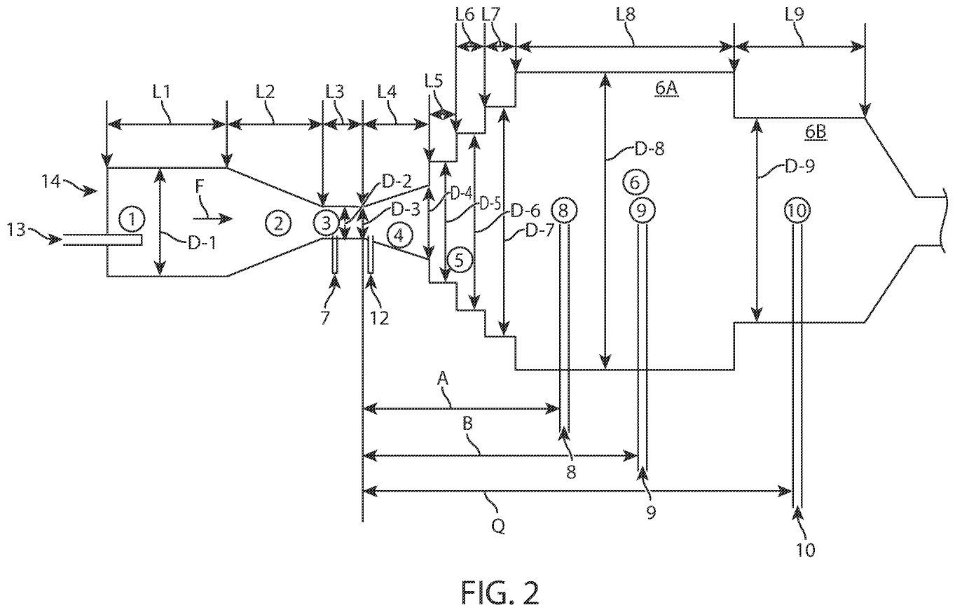

In the methods of the present invention, the method can include injection of oxygen downstream of the feedstock introduction point and upstream of a quench. The molar ratio of downstream oxygen to the amount of oxidant stream that is added to a combustion zone of a carbon black reactor can be from 0 to about 1:4, or from about 0.1:4 to about 1:4, or from about 0.2:4 to 0.9:4, or from about 0.3:4 to about 0.8:4 and the like. Referring to FIG. 2, for example, the molar ratio of downstream oxygen to the amount of oxidant stream 14 that is added to combustion zone 1 can be as described above.

Regarding the at least one feedstock introduction point, this can be one or two or more feedstock introduction points. When two or more are present, at least one feedstock introduction point can be downstream of at least one other feedstock introduction point.

In general, the carbon black reactor includes or comprises a combustion zone, a transition zone, and a reaction zone. For instance, the carbon black reactor can include or comprise a combustion zone, a transition zone, a conical entry section, a stepped entry section, a reaction zone, and a quench zone. Examples of suitable reactors include but are not limited to those described in U.S. Pat. Nos. 3,922,335, 4,383,973, 5,190,739, 5,877,250, 5,904,762, 6,153,684, 6,156,837, 6,403,695, 6,485,693, 7,829,057, 8,871,173, 10,829,642, 6,926,877, 6,156,837, 5,190,739, and 5,877,251, the entire contents of all of which are incorporated herein by reference. Any one of these reactors can be used to implement and include the operation parameters and components described herein to make the carbon blacks of the present invention.

In the methods to form the carbon black, at least one feedstock additive is utilized as indicated, which is or includes strontium or barium or a combination thereof.

In general, the feedstock additive can be substances that are a solid, solution, dispersion, gas, or any combination thereof. For purposes of the present invention, the substances can be the metal (or metal ion) itself, a compound containing one or more of these elements, including a salt containing one or more of these elements, and the like. Exemplary Sr and/or Ba metal salts include both organic and inorganic salts, for example, salts, with any of chloride, acetate, or formate, or combinations of two or more such salts. The form of the feedstock additive is capable, for example, of introducing a Sr and/or Ba metal or metal ion into the reaction that is ongoing to form the carbon black product.

The feedstock additive can preferably be in the form of an aqueous liquid containing at least a strontium salt and/or a barium salt dissolved therein. Nonetheless, the amount of additive added to the feedstock is described herein as an amount of elemental metal with respect to the amount of feedstock to which the additive is added and excludes residual impurities, including elemental metals, that are typically present in a feedstock additive formulation. Thus, the amount of additive does not account for the aqueous liquid, the counterion of the metal salt, or any metallic impurities in the feedstock additive.

The amount of feedstock additive supplied to the one or more feedstock introduction point or introduction point (e.g., feedstock additive introduction point) can be an amount of from 50 ppm to 1500 ppm or more (based on elemental metal, in ionic or neutral form, excluding residual impurities) and this amount is based on ppm levels (weight ppm) of elemental metal, excluding residual impurities, added to the feedstock prior to any reaction occurring or pyrolysis occurring in the carbon black reactor. The amount can be from 60 ppm to 1500 ppm, from 75 ppm to 1500 ppm, from 100 ppm to 1500 ppm, from 125 to 1500 ppm, from 150 ppm to 1500 ppm, from 175 ppm to 1500 ppm, from 200 ppm to 1500 ppm, from 250 ppm to 1450 ppm, from 250 ppm to 1400 ppm, from 250 ppm to 1350 ppm, from 250 ppm to 1300 ppm, from 250 ppm to 1200 ppm, from 250 ppm to 1100 ppm, from 250 ppm to 1000 ppm, from 250 ppm to 900 ppm, from 250 ppm to 800 ppm, from 250 ppm to 700 ppm, from 250 ppm to 600 ppm, from 250 ppm to 500 ppm, from 250 ppm to 400 ppm, from 300 ppm to 1500 ppm, from 350 ppm to 1500 ppm, from 400 ppm to 1500 ppm, from 450 ppm to 1500 ppm, from 500 ppm to 1500 ppm, from 550 ppm to 1500 ppm, from 600 ppm to 1500 ppm, from 650 ppm to 1500 ppm, from 700 ppm to 1500 ppm, from 750 ppm to 1500 ppm, from 800 ppm to 1500 ppm, and any amounts above or below any one of the ranges or any combination of one end point of one range with another end point of a second range. These amounts can apply to overall feedstock additive or can apply to strontium, barium, or both in the feedstock.

Regarding the feedstock additive amounts as particularly described immediately above, amounts above 1500 ppm, which can be used, tend not to provide any additional benefits compared to amounts of 1500 ppm or lower. Further, amounts above 1500 ppm can generally provide undesirably higher ash contents to the resulting carbon black formed. Thus, with the methods of the present invention, it was discovered that the amount of feedstock additives utilized are preferably 50 ppm to 1500 ppm and more preferably 250 ppm to 1500 ppm.

As an option, and preferably, the strontium and/or barium is present in the at least one feedstock additive at the largest weight percentage compared to any metal element that may be optionally present in the feedstock additive (based on total weight of feedstock additives).

As an option, the feedstock additive can be strontium and at least one other metal element (other than barium, for instance, calcium) to form a total amount of metal elements. In such an embodiment, the strontium can be present, for example, from 30 wt % to 99 wt % of the total amount of the metal elements present (or based on total weight of feedstock additives), excluding residual impurities (e.g., from 33 wt % to 99 wt %, from 35 wt % to 99 wt %, from 40 wt % to 99 wt %, from 45 wt % to 99 wt %, from 50 wt % to 99 wt %, from 55 wt % to 99 wt %, from 60 wt % to 99 wt %, from 70 wt % to 99 wt %, from 80 wt % to 99 wt %, from 85 wt % to 99 wt %, from 90 wt % to 99 wt %, from 95 wt % to 99 wt %).

As an option, the feedstock additive can be barium and at least one other metal element (other than strontium, for instance, calcium) to form a total amount of metal elements. In such an embodiment, the barium can be present, for example, from 30 wt % to 99 wt % of the total amount of the metal elements present (or based on total weight of feedstock additives), excluding residual impurities (e.g., from 33 wt % to 99 wt %, from 35 wt % to 99 wt %, from 40 wt % to 99 wt %, from 45 wt % to 99 wt %, from 50 wt % to 99 wt %, from 55 wt % to 99 wt %, from 60 wt % to 99 wt %, from 70 wt % to 99 wt %, from 80 wt % to 99 wt %, from 85 wt % to 99 wt %, from 90 wt % to 99 wt %, from 95 wt % to 99 wt %).

The amount of feedstock additive utilized in the methods of the present invention can alternatively be characterized as utilizing a sufficient amount such that the resulting carbon black formed has from about 100 ppm to about 7,000 ppm or more of elemental strontium or barium or both. The strontium and/or barium (and optionally other additives) can be uniformly dispersed throughout the carbon black. This amount can be from 100 ppm to 7,000 ppm, from 100 ppm to 6,500 ppm, from 100 ppm to 6,000 ppm, from 100 ppm to 5,500 ppm, from 100 ppm to 5,000 ppm, from 100 ppm to 4,500 ppm, from 100 ppm to 4,000 ppm, from 100 ppm to 3,500 ppm, from 100 ppm to 3,000 ppm, from 100 ppm to 2,500 ppm, from 100 ppm to 2,000 ppm, from 100 ppm to 1,500 ppm, from 100 ppm to 1,000 ppm, from 100 ppm to 500 ppm, from 150 ppm to 7,000 ppm, from 200 ppm to 7,000 ppm, from 250 ppm to 7,000 ppm, from 300 ppm to 7,000 ppm, from 350 ppm to 7,000 ppm, from 400 ppm to 7,000 ppm, from 450 ppm to 7,000 ppm, from 500 ppm to 7,000 ppm, from 550 ppm to 7,000 ppm, from 600 ppm to 7,000 ppm, from 650 ppm to 7,000 ppm, from 700 ppm to 7,000 ppm, from 750 ppm to 7,000 ppm, from 800 ppm to 7,000 ppm, from 850 ppm to 7,000 ppm, from 900 ppm to 7,000 ppm, from 950 ppm to 7,000 ppm, from 1,000 ppm to 7,000 ppm, from 1,000 ppm to 6,500 ppm, from 1000 ppm to 6,000 ppm, from 1,000 ppm to 5,500 ppm, from 1,000 to 5,000 ppm, from 1,000 ppm to 4,500 ppm, from 1,000 ppm to 4,000 ppm, from 1,000 ppm to 3,500 ppm, from 1,000 ppm to 3,000 ppm, from 1,000 ppm to 2,500 ppm, from 1,000 ppm to 2,000 ppm, from 1,000 to 1,500 ppm, from 1,500 ppm to 7,000 ppm, from 2,000 ppm to 7,000 ppm, from 2,500 ppm to 7,000 ppm, from 3,000 ppm to 7,000 ppm, from 3,500 ppm to 7,000 ppm, from 4,000 ppm to 7,000 ppm, from 4,500 ppm to 7,000 ppm, from 5,000 ppm to 7,000 ppm, from 5,500 ppm to 7,000 ppm, from 6,000 ppm to 7,000 ppm, from 6,500 ppm to 7,000 ppm.

Regarding the amount of feedstock additive utilized in the methods of the present invention so as to form a resulting carbon black having from about 100 ppm to about 7,000 ppm strontium and/or barium present as particularly described immediately above, additive amounts above 7,000 ppm in the carbon black formed can be achieved, but tend not to provide any additional benefits compared to amounts of 7000 ppm or lower in the carbon black. Further, amounts above 7000 ppm in the carbon black can generally be accompanied by undesirably higher ash contents in the carbon black.

Other metallic elements in the feedstock additive can be or include calcium.

Other metallic elements in the feedstock additive can be or include a Group IA element and/or calcium, which can be introduced, at any point. Any optional feedstock additive, such as calcium can be introduced at the same or different time and/or the same or different location and/or be combined with the Sr and/or Ba additive prior to introduction into the reactor.

The amount of the Group IA element and/or calcium can be an amount of less than 500 ppm based on total feedstock amount. This amount is based on ppm levels of the metallic elements added to the feedstock, excluding residual impurities, and not accounting for any counterions or solvents that are part of the feedstock additive, prior to any reaction occurring or pyrolysis occurring in the carbon black reactor. This amount can be less than 450 ppm, less than 400 ppm, less than 350 ppm, less than 300 ppm, less than 250 ppm, less than 200 ppm, less than 150 ppm, less than 100 ppm, less than 50 ppm, less than 25 ppm, less than 15 ppm, less than 10 ppm, less than 1 ppm, from 1 ppm to 499 ppm, from 10 ppm to 450 ppm, from 25 ppm to 425 ppm, from 50 ppm to 475 ppm, from 75 ppm to 450 ppm, from 100 ppm to 400 ppm. These amounts can apply to a total combined amount of a Group IA element (if used) and calcium (if used) or these amounts can individually apply to calcium and individually apply to one or more Group IA elements.

For example, a Group IA element can be introduced, at any point, in an amount of less than 10 ppm based on total feedstock amount and calcium can also be introduced, at any point, in an amount of less than 10 ppm based on total feedstock amount.

As another example, no Group IA element is introduced, at any point, and less than 500 ppm calcium is introduced, at any point.

As indicated, the use of a Group IA element and/or calcium is optional, and thus an option, no Group IA element is introduced or present. As an option, no calcium is introduced or present. As an option, less than 50 ppm of calcium is present.

As an option, no potassium additive is introduced and no potassium is present in the carbon black formed.

As an option, 100 ppm or less of potassium additive is introduced in the methods of the present invention. And, the carbon black formed can contain 100 ppm or less of elemental potassium in the carbon black formed. The amount of potassium additive present or introduced in the methods of the present invention can be 90 ppm or less, 80 ppm or less, 70 ppm or less, 60 ppm or less, 50 ppm or less, 40 ppm or less, 30 ppm or less, 20 ppm or less, 15 ppm or less, 5 ppm or less, 4 ppm or less, 3 ppm or less, 2 ppm or less, or 1 ppm or less. The amount of potassium additive can be from 0.1 ppm to 100 ppm or from 0.5 ppm to 100 ppm, or from 1 ppm to 100 ppm.

The amount of potassium present in the carbon black formed can be can be 100 ppm or less, 90 ppm or less, 80 ppm or less, 70 ppm or less, 60 ppm or less, 50 ppm or less, 40 ppm or less, 30 ppm or less, 20 ppm or less, 15 ppm or less, 5 ppm or less, 4 ppm or less, 3 ppm or less, 2 ppm or less, or 1 ppm or less, or from 1 ppm to 100 ppm or from 5 ppm to 20 ppm, or from 1 ppm to 50 ppm (based on the total weight of the carbon black).

As an option, no sodium additive is introduced and no sodium is present in the carbon black formed. As an option the amount of sodium additive introduced in the methods or present in the carbon black can be 100 ppm or less, 50 ppm or less, 20 ppm or less, 10 ppm or less, 5 ppm or less, or 1 ppm or less, or 0.1 ppm or less. The amount of sodium present in the carbon black formed can be can be 100 ppm or less, 90 ppm or less, 80 ppm or less, 70 ppm or less, 60 ppm or less, 50 ppm or less, 40 ppm or less, 30 ppm or less, 20 ppm or less, 10 ppm or less, 5 ppm or less, 4 ppm or less, 3 ppm or less, 2 ppm or less, or 1 ppm or less, or from 1 ppm to 100 ppm or from 5 ppm to 100 ppm, or from 1 ppm to 50 ppm (based on the total weight of the carbon black).

Examples of Group IA elements include lithium, sodium, potassium, rubidium, cesium, or francium, or any combination of two or more of these. These elements can be included in feedstock additives can that are a solid, solution, dispersion, gas, or any combination thereof. For purposes of the present invention, the substances can be the metal (or metal ion) itself, a compound containing one or more of these elements, including a salt containing one or more of these elements, and the like. Exemplary Group IA metal salts include both organic and inorganic salts, for example, salts, e.g., of sodium and/or potassium, with any of chloride, acetate, or formate, or combinations of two or more such salts.

With regards to the feedstock additives, whether strontium and/or barium is used alone or used with other metallic elements such as calcium, the substances can be added together, separately, sequentially, or in different reaction locations. For instance, the substances can be added at any point prior to the complete quenching, including, for example, prior to the introduction of the carbon black yielding feedstock in zone 1 or 2 (of FIG. 2); during the introduction of the carbon black yielding feedstock in zone 3; after the introduction of the carbon black yielding feedstock in zones 4-10; or any step prior to complete quenching. More than one point of introduction of the feedstock additive can be used.

The feedstock additive(s) can be added in any fashion including any conventional means. In other words, the feedstock additive(s) can be added in the same manner that a carbon black yielding feedstock is introduced. The substance can be added as a gas, liquid, or solid, or any combination thereof. The feedstock additive(s) can be added at one point or several points, such as illustrated as point 12 in FIG. 2, and can be added as a single stream or a plurality of streams. The feedstock additive(s) also or alternatively can be mixed in with the feedstock, fuel, and/or oxidant prior to and/or during their introduction, such as, for example, one or more of feed streams 7, 13, and 14 shown in FIG. 2, or at other reactor locations. The feedstock additive(s) can be introduced at different points and/or through separate injectors and/or lances in the reactor (not shown).

With the methods of the present invention, as indicated earlier, there are advantages to utilizing strontium and/or barium instead of the calcium by itself as a feedstock additive. For instance, in the methods of the present invention, the methods can form carbon black having a surface area and a structure and wherein the carbon black reactor is operated at a desired OAC (%) due, at least in part, to the heated gas stream and a temperature of the reaction stream, and this OAC (%) is at least 4% lower to form the carbon black (having the surface area and structure) compared to a method that utilizes only calcium (and not strontium or barium) at the same amount for the feedstock additive but is otherwise the same method. The ‘at least 4% lower” in OAC (%) can be at least 5%, at least 6%, at least 7%, such as from 4% to 10% lower or 5% to 8% lower, or 4% to 6% lower in OAC (%), meaning that the value of OAC, as a percent, is a certain percent lower in the inventive method (i.e., the difference in OAC values is subtracted, divided by the OAC value for the method utilizing only calcium, and multiplied by 100).

While reference to methods to form carbon blacks is made, the process can be considered a furnace carbon black process that forms furnace carbon blacks or furnace blacks.

FIG. 2 shows an illustrative portion of one type of carbon black reactor that can be used to produce carbon blacks of the present invention taking into account the process conditions and components and additives described herein. Process conditions and reactor arrangements for production of the carbon blacks of the present invention can include the following features.

In general, to make the carbon blacks of the present invention, one or more or all of the following process conditions and equipment arrangements 1) and optionally with 2)-4) can be used. At least 1) is always used and preferably with 2), or 3), or 4) or 2)-3), or 3)-4), or 2)-4). The process conditions and equipment arrangements are as follows:
1) introduction (e.g., injection) of the indicated amounts of strontium and/or barium elements or ions thereof (e.g., Sr/Sr²⁺, Ba/Ba²⁺).
2) optional injection of water and oxygen downstream of the introduction point(s) of the carbon black yielding feedstock but upstream of the quench to increase temperature and provide a moist environment.
3) optional introduction or addition of calcium in the reactor to etch the carbon black therein.
4) optional introduction (e.g., injection) of amounts of potassium or other Group IA elements or ions thereof of the Periodic Table (e.g., Na/Na⁺, K/K⁺, Cs/Cs⁺).

In one aspect, the present carbon blacks are produced, for example, in a furnace carbon black reactor, such as that depicted in FIG. 2, having a combustion zone 1, which has a zone of converging diameter 2, transition zone 3, conical entry section 4, stepped entry section 5, and reaction zone 6. The diameter of the combustion zone 1, up to the point where the zone of converging diameter 2 begins, is shown as D-1; the diameter of zone 3, as D-2; the entry and exit diameters of conical zone 4 as D-3 and D-4, respectively; the diameters of stepped entry zone 5 as D-5, D-6, D-7; and the diameters of reaction zone 6 as D-8 and D-9. The length of the combustion zone 1, up to the point where the zone of converging diameter 2 begins, is shown as L-1; the length of the zone of converging diameter is shown as L-2; the length of the transition zone is shown as L-3; the length of the conical section, zone 4, as L-4; and the lengths of the steps in the reactor entry section, zone 5, as L-5, L-6, and L-7. The lengths of the reaction zone 6 are L-8 and L-9.

To produce carbon blacks, hot combustion gases (also referred to as a heated gas stream) are generated in combustion zone 1, by contacting a liquid or gaseous fuel 13 with a suitable oxidant stream 14 such as air, oxygen, mixtures of air and oxygen or the like. When oxygen is added to the oxidant stream (herein referred to as “enrichment oxygen”), it is added so as to enrich the oxygen content of the air to levels from about 21% to about 35%. Among the fuels suitable for use in contacting the oxidant stream in combustion zone 1 to generate the hot combustion gases are any of the readily combustible gas, vapor, or liquid streams such as natural gas, hydrogen, carbon monoxide, methane, acetylene, alcohol, or kerosene. Generally, the fuels have a high content of carbon-containing components, in particular, hydrocarbons. As an example, the volumetric ratio of air to natural gas utilized to produce the carbon blacks of the present invention can be from about 5:1 to about 100:1. To facilitate the generation of hot combustion gases, the oxidant stream may be preheated.

The hot combustion gas stream (or heated gas stream) flows downstream from zones 1 and 2 into zones 3, 4, 5, and 6. The direction of the flow of hot combustion gases is shown in FIG. 2 by the “F” arrow. Carbon black-yielding feedstock (also referred to a carbon black feedstock) can be introduced at point 7 (located in zone 3). Suitable for use herein as carbon black-yielding hydrocarbon feedstocks, which are readily volatilizable under the conditions of the reaction, are unsaturated hydrocarbons such as acetylene; olefins such as ethylene, propylene, butylene; aromatics such as benzene, toluene and xylene; certain saturated hydrocarbons; and other hydrocarbons such as kerosenes, naphthalenes, terpenes, ethylene tars, aromatic cycle stocks and the like. The feedstock additive(s) can be introduced at point 7 or other points in zone 3 or other zones. The feedstock additive can be pre-combined with the carbon black-yielding feedstock or added separately to the reactor.

As an option, feedstocks with lower sulfur content can be used. Sulfur levels can be, for example, from 0 to about 5 wt %, or from 0 to about 1 wt %, or 0 to about 0.5 wt %, or from 0 to about 0.1 wt %, based on total carbon black yielding feedstock used in the entire process. These sulfur level ranges and amounts also can apply to any individual carbon black yielding feedstock stream.

Generally, carbon black-yielding feedstock (alone or combined with the feedstock additive) is injected at point 7 in the form of a plurality of streams (not shown) which penetrate into the interior regions of the hot combustion gas stream to insure a high rate of mixing and shearing of the carbon black-yielding feedstock by the hot combustion gases so as to rapidly and completely decompose and convert the feedstock to carbon black.

The mixture (also referred to the reaction stream) of carbon black-yielding feedstock (with the feedstock additive) and hot combustion gases flows downstream through zone 3 into zones 4, 5, and 6. Water can be injected into zone 6 at point 8 in the reactor. Without being bound by any particular theory, this water can vaporize into steam, which increases the concentration of gaseous species that can oxidize carbon, resulting in an increased rate of oxidative attack of the carbon black surface. This can result in an etched or porous carbon black. The weight ratio of the amount of injected water to the carbon black-yielding feedstock is typically from 0 to about 1:1, or from about 0.1:1 to about 1:1, or from about 0.2:1 to about 0.5:1, or from about 0.3:1 to about 0.7:1, or from about 0.4:1 to about 0.8:1 and the like. This water (herein referred to as “intermediate water”) is differentiated from the quench water, located at point 10, whose purpose is to stop the reaction. In FIG. 2, “A” is the distance from the beginning of zone 4 to intermediate water point 8, and will vary according to the position of the intermediate water injection. Oxygen gas (herein referred to as “intermediate oxygen”) can be added to zone 6 at point 9. Without being bound by any particular theory, the oxygen can react with combustible species like carbon monoxide and hydrogen in the gas to increase the temperature of the system, thereby increasing the rate of oxidative attack of the carbon black surface, resulting in etched or porous carbon black with higher surface area than carbon black untreated with oxygen gas. The molar ratio of intermediate oxygen to the amount of air that is added to Zone 1 can be from 0 to about 1:4, or from about 0.1:4 to about 1:4, or from about 0.2:4 to 0.9:4, or from about 0.3:4 to about 0.8:4 and the like. In FIG. 2, “B” is the distance from the beginning of zone 4 to intermediate oxygen point 9, and can vary according to the position of the intermediate oxygen injection. As an example, water and oxygen can be injected downstream of the carbon black-yielding feedstock introduction point and upstream of the quenching, effective to increase the temperature at least about 5%, or at least about 10%, or at least about 15%, or at least about 20%, and/or increase the moisture content at least about 5%, or at least about 10%, or at least about 15%, or at least about 20%, in the reactor relative to the temperature and the moisture content in the reactor without injecting the water and the oxygen and all other conditions the same.

As indicated, the feedstock additive by itself and/or pre-combined can be introduced into the reactor at one or more various points of the reactor (referring to FIG. 2, these points can be or include points 3, 4, 5, 8, 6, and/or 9.

Quench 11 of the reactor, located at point 10, injects a quenching fluid, which may be water, and is utilized to stop the further formation of carbon blacks. Point 10 may be determined in any manner known to the art for selecting the position of a quench to stop pyrolysis. In FIG. 2, “Q” is the distance from the beginning of zone 4 to quench point 10, and will vary according to the position of the quench. For these carbon blacks, as an example, Q can be maximized to maximize the available time for etching to create high surface area.

After the mixture of hot combustion gases and carbon black-yielding feedstock is quenched, the cooled gases pass downstream into any conventional cooling and separating apparatus whereby the carbon blacks are recovered. The separation of the carbon black from the gas stream is readily accomplished by a conventional apparatus such as a precipitator, cyclone separator or bag filter. This separation may be followed by pelletizing using, for example, a wet pelletizer.

As indicated, the present invention further relates to novel carbon blacks (e.g., furnace carbon blacks). In particular, the present invention relates to a carbon black having a nitrogen BET surface area (N2SA) of from 800 m²/g to 2,500 m²/g and a concentration of Group IIA elements in the carbon black can be less than or equal to 4.3*N2SA−2150 [Equation 2]. The concentration (ppm) of Group IIA elements in the carbon black can be an amount less than 4.3*N2SA−2150. The amount can be characterized as a % less than 4.3*N2SA−2150, such as at least 1% less, at least 5% less, at least 10% less, at least 15% less, or at least 20% less, such as from 1% to 50% less, preferably up to 75% less than 4.3*N2SA−2150. Preferably, the Group IIA elements at least comprises strontium, barium, or a combination thereof. Metallic elements in the carbon black, as indicated above, can further include, besides strontium, barium or both, a Group IA and/or additional Group IIA element. The ash content (wt %) in the carbon black can be equal to or less than 0.0012*N2SA−0.24 [Equation 3]. The ash content (wt %) in the carbon black can be less than 0.0012*N2SA−0.24.

Referring to Equation 3, the ash content (wt %) can be at least 1% less than the number resulting from Equation 3 or can be at least 2% less, 3% less, 5% less, 7% less, 10% less, 15% less, 20% less, or 25% less, such as from 1% to 25% less than the number resulting from Equation 3.

The Group IIA and Group IA elements in the carbon black are a result of the ‘feedstock additive’ that includes metallic elements including or consisting essentially of strontium and/or barium, and the description and parameters mentioned earlier for this feedstock additive can equally apply here to the Group IIA and Group IA elements contained in the carbon black product.

The carbon black of the present invention can have an N2SA of from 800 m²/g to 2,500 m²/g, such as from 900 m²/g to 2,400 m²/g, or from 850 m²/g to 2,400 m²/g, or from 825 m²/g to 2,500 m²/g, or from 850 m²/g to 2,500 m²/g, or from 875 m²/g to 2,500 m²/g, or from 900 m²/g to 2,500 m²/g, or from 925 m²/g to 2,500 m²/g, or from 950 m²/g to 2,500 m²/g, or from 1,000 m²/g to 2,500 m²/g, or from 1,100 m²/g to 2,500 m²/g, or from 1,200 m²/g to 2,500 m²/g, or from 1,250 m²/g to 2,500 m²/g, or from 1,300 m²/g to 2,500 m²/g, or from 800 m²/g to 2,450 m²/g, or from 800 m²/g to 2,400 m²/g, or from 800 m²/g to 2,350 m²/g, or from 800 m²/g to 2,300 m²/g, or from 800 m²/g to 2,250 m²/g, or from 800 m²/g to 2,200 m²/g, or from 800 m²/g to 2,150 m²/g, or from 800 m²/g to 2,100 m²/g, or from 800 m²/g to 2,050 m²/g, or from 800 m²/g to 2,000 m²/g, or from 800 m²/g to 1,950 m²/g, or from 800 m²/g to 1,900 m²/g, or from 800 m²/g to 1,800 m²/g, or from 800 m²/g to 1,700 m²/g, or any N2SA that is below or above any of these ranges or any range defined by any combination of one end point of one range with another end point of a second range. The N2SA is nitrogen BET surface area measured as described above.

As an option, the concentration (ppm) of Group IIA elements in the carbon black can be from 100 to 7000 ppm (by weight, based on the total mass of the carbon black). For example, the concentration of Group IIA elements can be from 200 ppm to 6500 ppm, from 300 ppm to 6000 ppm, from 400 ppm to 5000 ppm, from 500 ppm to 4000 ppm, from 600 ppm to 7000 ppm, or from 800 ppm to 6500 ppm, or any range defined by any combination of one end point of one range with another end point of a second range.

As an option, the concentration (ppm) of strontium and/or barium in the carbon black can be from 100 to 7000 ppm (by weight, based on the total mass of the carbon black). For example, the concentration of Group IIA elements can be from 200 ppm to 6500 ppm, from 300 ppm to 6000 ppm, from 400 ppm to 5000 ppm, from 500 ppm to 4000 ppm, from 600 ppm to 7000 ppm, or from 800 ppm to 6500 ppm, or any range defined by any combination of one end point of one range with another end point of a second range.

As a result of the feedstock additives described above, the carbon black can include only strontium or barium, or a combination thereof.

As a result of the use of the feedstock additives described above, the carbon black can include only Group IIA elements that at least include strontium and/or barium.

The total weight of Group IIA elements present can be at least 30% by weight strontium based on total weight of said Group IIA elements, or at least 35% by weight strontium, or at least 40% by weight strontium, or at least 50% by weight strontium, or at least 60% by weight strontium, or at least 70% by weight strontium, or at least 80% by weight strontium based on total weight of said Group IIA elements, or at least 99% by weight strontium based on total weight of said Group IIA elements.

The total weight of Group IIA elements present can be at least 30% by weight barium based on total weight of said Group IIA elements, or at least 35% by weight barium, or at least 40% by weight barium, or at least 50% by weight barium, or at least 60% by weight barium, or at least 70% by weight barium, or at least 80% by weight barium based on total weight of said additive, or at least 99% by weight barium based on total weight of said Group IIA elements.

If present together (strontium and barium), the total weight of Group IIA elements present can be at least 30% by weight strontium/barium based on total weight of said Group IIA elements, or at least 35% by weight strontium/barium, or at least 40% by weight strontium/barium, or at least 50% by weight strontium/barium, or at least 60% by weight strontium/barium, or at least 70% by weight strontium/barium, or at least 80% by weight strontium/barium based on total weight of said Group IIA elements, or at least 99% by weight strontium/barium based on total weight of said Group IIA elements.

The total weight of Group IIA elements present can be at least 30% by weight strontium or barium or a combination thereof and 70% or less by weight can be one or more other additives, such as, but not limited to, calcium. The weight ratio of the Group IIA elements that is strontium, barium or a combination thereof (A) to other additives (e.g., Ca) (B) can be a weight ratio A:B of 99:1 to 30:70, such as 98:2 to 50:50, 95:5 to 50:50, 90:10 to 50:50, 80:20 to 50:50, 70:30 to 50:50, 60:40 to 50:50, 99:1 to 51:49, 99:1 to 55:45, 99:1 to 60:40, 99:1 to 65:35, 95:1 to 55:45, 95:1 to 60:40, 95:1 to 65:35, 30:70 to 99:1, 35:65 to 99:1, 40:60 to 99:1, 45:55 to 99:1, and other amounts within or outside of these ranges specified.

As an option, the carbon black has less than 0.1 wt % or less than 500 ppm or less than 250 ppm or less than 100 ppm or less than 50 ppm or less than 25 ppm or less than 5 ppm or less than 1 ppm or 0 ppm calcium.

As an option, the carbon black has less than 0.1 wt % or less than 500 ppm or less than 250 ppm or less than 100 ppm or less than 50 ppm or less than 25 ppm or less than 5 ppm or less than 1 ppm or 0 ppm potassium and/or sodium.

As an option, the carbon black has less than 0.1 wt % or less than 500 ppm or less than 250 ppm or less than 100 ppm or less than 50 ppm or less than 25 ppm or less than 20 ppm or less than 15 ppm or 0 ppm Group IA element.

A simplified description of a carbon black particle is an aggregate of a number of particulates, which are referred to as the primary particles (“primaries”). The size of primaries in a carbon black particle can vary, but production of carbon black with primaries of size (diameter) down to at least about 8 nm is feasible, such as with, for example, the processes illustrated herein. The number of primaries in the aggregate can also vary, for example, from about one to about few tens or possibly hundreds, thus resulting in the carbon black particle size of up to about 500 nm. The number of primaries and the arrangement of them in the carbon black particle not only dictate the size of the carbon black particle but also the structure of the carbon black.

The average primary particle size is determined by ASTM D3849-04, the entirety of which is incorporated herein by reference, and can be, for example, less than about 100 nm, or less than about 75 nm, or less than about 50 nm, or less than about 30 nm, or less than about 20 nm, or less than about 10 nm. The carbon black aggregates can be, for example, assemblies of primary carbon black particles that are fused at the contact points and cannot readily be separated by shearing. The average aggregate size of the carbon black may be extracted from TEM image analysis using the imaging technique described in ASTM D3849-04, the entirety of which is incorporated herein by reference. The carbon black can have an average aggregate size that is, for example, less than about 500 nm, or less than about 400 nm, or less than about 300 nm, or less than about 200 nm, or less than about 100 nm.

The average primary particle size and/or an average aggregate particle size that the present carbon black can have, but are not limited to, the carbon black can have one or more of the following properties:
a) an average primary particle size of from about 8 nm to about 100 nm, or from about 8 nm to about 50 nm, or from about 9 nm to about 40 nm, or from about 9 nm to about 30 nm, or from about 10 nm to about 20 nm, or from about 10 to about 15 nm;
b) an average aggregate particle size of from about 8 nm to about 500 nm, or from about 20 nm to about 400 nm, or from about 30 to about 300 nm, or from about 50 nm to about 250 nm, or from about 75 nm to about 200 nm, or from about 100 nm to about 175 nm, or from about 125 nm to about 150 nm, or from about 50 nm to about 70 nm, or from about 55 nm to about 65 nm, or from about 58 nm to about 62 nm. For example, the present carbon black can have an average size of primaries of from about 8 nm to about 100 nm, and an average size of carbon black particles of from about from about 8 nm to about 500 nm.

The carbon blacks of the present invention can be prepared, for example, by simultaneously adjusting the burner natural gas rate, enrichment oxygen rate, feedstock rate, feedstock type, feedstock additive element concentration in the feedstock, optional Group IA element concentration in the feedstock, intermediate water rate and location, and intermediate oxygen rate and location to achieve the desired properties. Selection of the particular reactor geometry described herein also can be significant in achieving the desired properties. The surface area of the carbon black can be increased, for example, by increasing the burner natural gas rate, increasing the enrichment oxygen rate, decreasing the feedstock rate, increasing the feedstock additive element concentration, increasing the Sr and/or Ba concentration in the feedstock additive (e.g., going from 30/70 Sr/Ca to 90/10 Sr/Ca), and/or increasing the intermediate water rate while simultaneously increasing the intermediate oxygen rate. The exact levels of each variable required to create carbon black with the desired properties can depend on the geometry of the reactor and the method of injection of each species into the reactor.

The present carbon black product can be in the form of a powder or finely divided form. The present carbon black also can be, for example, pelletized, agglomerated, or mixed with any other substance, such as particles, liquids, solids, polymers, or other materials.

A typical feedstock additive used in carbon black production is calcium or potassium, or sodium or combinations thereof. The use of strontium and/or barium as a feedstock additive was not considered an option that would have any particular benefit to carbon black manufacturing, especially compared to calcium. Thus, it was quite unexpected when it was discovered that the use of strontium alone, the use of barium alone and/or the use of a combination of strontium and barium or the use of strontium and/or barium with an amount of calcium did not produce comparable results, but actually produced significant and unexpectedly superior results in several areas.

As described above and/or shown in the Examples, the present invention can provide the following unique and unexpected properties and/or advantages, especially compared to using the standard calcium additive alone as a feedstock additive during carbon black manufacturing: 1) the same or about the same N2SA carbon black can be formed using less ppm of Sr (as compared to Ca) (where ‘about the same’ means within 10% or within 5%). The % of ppm of Sr (as compared to Ca) can be at least 25% lower, at least 50% lower, at least 60% lower, at least 75% lower, at least 80% lower (as compared to Ca); 2) a higher N2SA carbon black can be formed using less ppm of Sr (as compared to Ca). The % higher in N2SA can be at least 10% higher, at least 20% higher, at least 30% higher, at least 40% higher, or at least 50% higher (as compared to Ca but at a lower ppm amount) and the % of ppm of Sr (as compared to Ca) can be at least 25% lower, at least 50% lower, at least 60% lower, at least 75% lower, at least 80% lower (as compared to Ca); 3) the same or about the same N2SA carbon black can be formed at a lower OAC (as compared to Ca). The % lower OAC (as a difference in the OAC for the different operating conditions) can be at least 1%, at least 2%, at least 3%, at least 4%, at least 5% and appreciating that each OAC % is significant in the carbon black industry. Thus, a lowering of OAC of 2% or more is quite significant; 4) a higher N2SA carbon black can be formed at a lower OAC (as compared to Ca). The % lower OAC can be at least 1%, at least 2%, at least 3%, at least 4%, at least 5% and appreciating that each OAC % is significant and the % higher in N2SA can be at least 10% higher, at least 20% higher, at least 30% higher, at least 40% higher, or at least 50% higher (as compared to Ca at a lower ppm amount). A-1: The above unique and unexpected properties and/or advantages 1), 2), 3), and 4) are especially more pronounced when the OAC used to make the carbon blacks is 32% and above, 32.5% and above, 33% and above, 33.5% and above, 34% and above, such as from 32% or 32.5% or 33% or 33.5% to 44%, 45%, 46%, 46.5%, 47%, or 48%. A-2: The above unique and unexpected properties and/or advantages 1), 2), 3), and 4) are especially more pronounced when the N2SA is 800 m²/g or above, or 900 m²/g or above, or 1000 m²/g or above, such as from 800 m²/g to 2500 m²/g or 900 m²/g to 2500 m²/g, or 1000 m²/g to 2500 m²/g. A-3: The above unique and unexpected properties and/or advantages 1), 2), 3), and 4) are especially more pronounced when the ppm amounts of Sr are at least 250 ppm, at least 300 ppm, at least 350 ppm, at least 400 ppm, at least 500 ppm, at least 600 ppm, or below 1000 ppm, or below 900 ppm, or below 800 ppm, or below 700 ppm, such as from 200 ppm to 1000 ppm. The reference to ppm amounts is with respect to the ppm of the additive in the feedstock (by mass).

The above unique and unexpected properties and/or advantages 1), 2), 3), and 4) and A-1 to A-3 equally apply to when the additive is Ba (as compared to Ca).

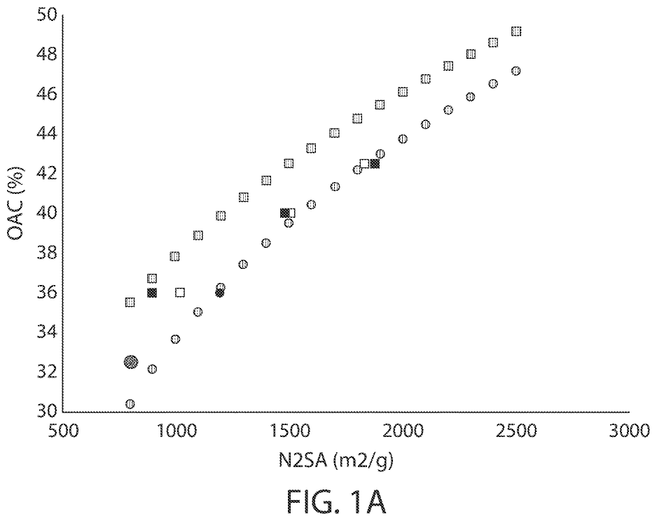

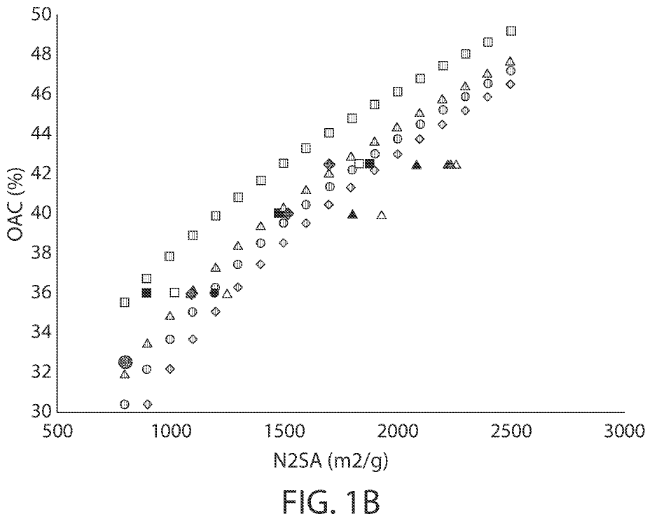

The above unique and unexpected properties and/or advantages are further shown in FIGS. 1, 3, and 4.

C-1: Unique and unexpected properties and/or advantages are also seen when Sr is used in combination with Ca (e.g., both are used as additives during the carbon black method). More specifically, by using a blend or combination of Sr and Ca, where Sr is present in a weight % amount of 30:70 (Sr:Ca) to 99:1 (Sr:Ca), a higher N2SA carbon black can be produced at the same additive loading (compared to 100% Ca at the same ppm loading). The Sr:Ca amount can be from 35:65, from 40:60, from 45:55, from 50:50, from 55:45, from 60:40, from 65:35, from 70:30, from 75:25, from 80:20, from 85:15, or from 90:10 to 99:1 (Sr:Ca). These unique and unexpected properties and/or advantages for the Sr:Ca blend/mixture/combination are especially more pronounced when the N2SA is 800 m²/g or above, or 825 m²/g or above, or 850 m²/g or above, or 1000 m²/g or above, such as from 800 m²/g to 2500 m²/g or 850 m²/g to 2500 m²/g, or 1000 m²/g to 2500 m²/g. The above unique and unexpected properties and/or advantages for the Sr:Ca blend/mixture/combination are especially more pronounced when the total additive amounts (Sr and Ca total) are at least 250 ppm, at least 300 ppm, at least 350 ppm, at least 400 ppm, at least 500 ppm, at least 600 ppm, at least 700 ppm, at least 800 ppm, at least 900 ppm at least 1000, at least 1100 ppm, at least 1200 ppm, at least 1300 ppm, at least 1400 ppm, at least 1500 ppm, such as from 250 ppm to 1500 ppm. The reference to ppm amounts in the feedstock is with respect to the ppm (by mass) of the metallic element with respect to the amount of feedstock to which it is added, excluding any residual impurities in the delivery vehicle (typically an aqueous salt solution) and not accounting for the counterion of the metallic salt or the aqueous carrier added to the feedstock.

The above unique and unexpected properties and/or advantages C-1 equally apply to when the additive is Ba instead of Sr in combination with Ca.

The above unique and unexpected properties and/or advantages C-1 are further shown, in part, by FIGS. 1A-B, 3, and 4. As explained in the examples section below, and as can be seen in the data, a lower OAC was possible to produce carbon black having a specified N2SA when Sr or Ba was used as the feedstock additive.

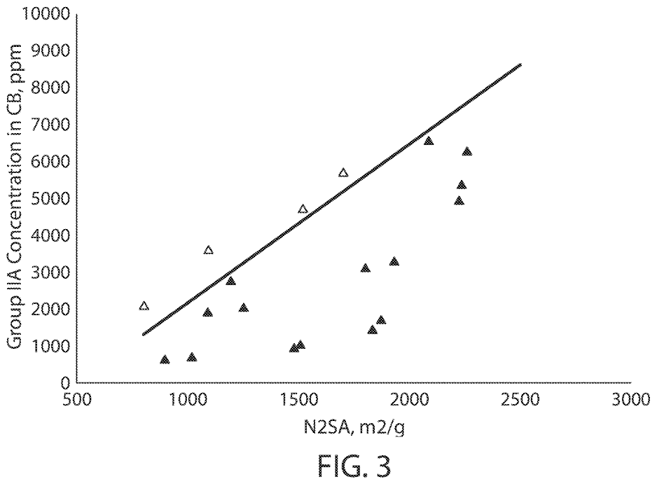

Further, as shown in FIG. 3, the data below the line are all examples where Sr or Ba were used as the feedstock additive, and the data above the line are all examples where Ca was used as the feedstock additive, and as can be seen, a much lower Group IIA element concentration (ppm) per indicated N2SA carbon black was achieved when Sr or Ba was used, allowing for lower ash formation on the carbon black.

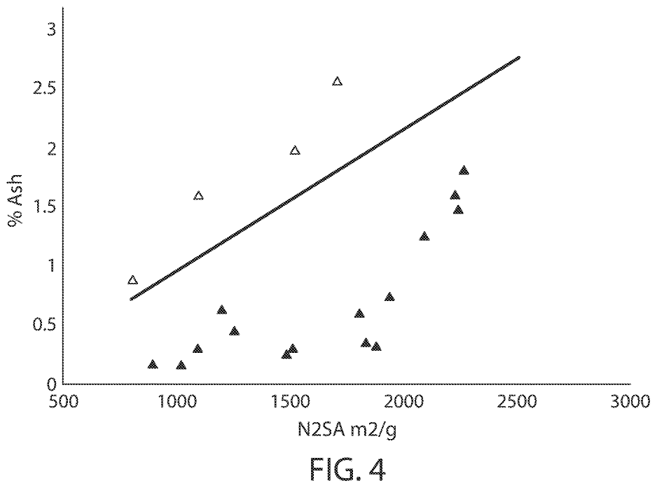

Further, as shown in FIG. 4, the data below the line are all examples where Sr or Ba were used as a feedstock additive, and the data above the line are all examples where Ca was used as the sole feedstock additive, and as can be seen, a much lower ash content (wt %) per indicated N2SA carbon black was achieved when Sr or Ba was used.

The present carbon blacks can be post-processed after exiting the reactor such as shown in FIG. 2, by, for example, water- or acid-washing, heat-treatment, and/or chemical molecular treatment. The post processing can be a simple water (hot or cold) or acid washing procedure or a heat treatment. The temperatures of heat treatment can be such that may result in some graphitization of carbon black. Alternatively, the temperatures can be such that they do not result in any additional graphitization, as, for example, below about 1100 °C, such as related in D. H. Everett, et al., J. Chem. Soc., Faraday Trans. I, 82, 2915-2928 (1986). The heat treatment can be done, for example, in an inert atmosphere, such as argon or nitrogen. Alternatively or in addition, the carbon black may be heat treated as described in U.S. Pat. No. 11,352,536 and/or US20130295462, the entire contents of both of which are incorporated herein by reference, to change surface characteristics such as Raman crystallite size, crystallinity, or water spreading pressure.

The present carbon blacks can have one or more chemical groups, such as organic groups attached to its surface (e.g., chemically attached, adsorbed, coated, or otherwise present). For example, the carbon black can have attached at least one organic group comprising an aromatic group and/or an alkyl group. The aromatic group or alkyl group can be directly attached to the carbon black (e.g., a carbon atom of the aromatic or alkyl group is attached (e.g., bonded) to the carbon black). Exemplary chemical groups, as well as methods to attach these groups to the conventional carbon black, are described in the following U.S. patents and publications, which are all incorporated in their entirety by reference herein: U.S. Pat. Nos. 5,851,280; 5,837,045; 5,803,959; 5,672,198; 5,571,311; 5,630,868; 5,707,432; 5,554,739; 5,689,016; 5,713,988; WO 96/18688; WO 97/47697; and WO 97/47699. The organic groups, which can be attached onto the carbon black, can be electron donor and/or electron acceptor groups. Alternatively, the organic groups, which can be attached onto the carbon black can include electron donor and/or electron acceptor groups. Yet another possibility is that electron donor and/or electron acceptor groups can be associated with the carbon black surface as counter ions. The organic groups that are attached onto carbon black could be simple small molecules, oligomers, or polymers. Examples of such electron donor and acceptor groups include, but are not limited to, substituted or un-substituted quinones; organometallic groups, such as substituted or un-substituted metallocenes (e.g., ferrocenes); substituted or un-substituted thiophenes/furans/pyrroles/carbazoles; substituted or un-substituted tetrathiafulvalene; and/or substituted or unsubstituted aromatic amines, for example, tri-phenylamines. Examples of polymeric electron donor and acceptor groups include, but not limited to, polythiophenes, polyacetylenes, polyphenylenevinylenes, polyanilines, and poly vinylcarbazoles.

The organic groups which can be attached onto the carbon black can be at least one or more ionic or ionizable groups or both. Ionic or ionizable functional groups forming anions or anionic groups include, for example, acidic groups or salts of acidic groups. Examples of organic groups that are anionic in nature include, but are not limited to, —C₆H₄—COO⁻X⁺; —C₆H₄—SO₃⁻X⁺; —C₆H₄—(PO₃)²⁻2X⁺; —C₆H₂—(COO⁻X⁺)₃; —C₆H₃—(COO⁻X⁺)₂; —(CH₂)₂—(COO⁻X⁻); —C₆H₄—(CH₂)₂—(COO⁻X⁺), wherein X⁺ is any cation such as Na⁺, H⁺, K⁺, NH₄⁺, Li⁺, Ca²⁺, Mg²⁺ and the like. As recognized by those skilled in the art, X⁺ may be formed in-situ as part of the manufacturing process or may be associated with the aromatic or alkyl group through a typical salt swap or ion-exchange process. Amine represents examples of ionizable functional groups that form cations or cationic groups. Quaternary ammonium groups, quaternary phosphonium groups and sulfonium groups also represent examples of cationic group. Examples of organic groups that are cationic in nature include, but are not limited to, —C₆H₄N(CH₃)₃⁺Y⁻, —C₆H₄COCH₂N(CH₃)₃⁺Y⁻, —C₆H₄ (NC₅H₅)⁺Y⁻, —(C₅H₄N)C₂H₅⁺Y⁻, —(C₃H₅N₂)⁺Y⁻ (imidazoles), (C₇H₇N₂)⁺Y⁻ (indazoles), —C₆H₄COCH₂ (NC₅H₅)⁺Y⁻, —(C₅H₄N)CH₃⁺Y⁻, and —C₆H₄CH₂N(CH₃)₃⁺Y⁻, wherein Y is any halide or an anion such as RSO₃⁻, SO₄²⁻, PO₄³⁻, NO₃⁻, OH₃⁻, CH₃COO⁻ and the like; or combinations thereof, wherein R is an alkyl or aromatic group. As recognized by those skilled in the art, Y″ may be formed in-situ as part of the manufacturing process or may be associated with the aromatic or alkyl group through a typical salt swap or ion-exchange process.

Any physically allowable treatment level of chemical groups (e.g., organic groups) with the carbon black is generally permitted. The treatment level of chemical groups with the carbon black, which may be expressed in terms of μmol/m² of carbon, of the chemical group (e.g., organic group) on the carbon black can be, for example, from about 0.1 to about 10 μmol/m² or more.

The carbon blacks of the present invention can have one type of chemical group (e.g., organic group) attached or more than one type of chemical group attached to its surface. In other words, dual or multi-treated modified carbon black can be used. Also, a mixture of modified carbon blacks having different chemical groups attached can be used.

The carbon blacks of the present invention can be used, for example, in a capacitor, for example, an electrochemical capacitor, battery or other energy storage device. The carbon black can be, for example, part of an electrode. The electrode can be in direct contact with a current collector, which generally is a metal (e.g., strip, rod, etc.), such as aluminum, aluminum with a thin conductive carbon coating, etched aluminum, and aluminum with a thin AlN coating, although other configurations also are contemplated.

For example, the carbon blacks of the present invention may be used as part of a battery paste. For lead acid batteries, a battery paste may include lead oxide and carbon black particles, along with one or more of the other components of expander formulations normally employed in the negative plates of lead-acid batteries, for example barium sulfate and/or a lignosulfonate or other organic material. In addition, the paste will contain sulfuric acid in sufficient amount to produce the desired consistency in the paste. To produce a battery plate, the components of the paste are added to a commercial paste mixing machine, mixed to the desired consistency and then applied to an electrically conducting lead alloy structure known as a grid. Typically, this pasted grid is then cured in a heated chamber containing air with a high relative humidity. This curing process produces the necessary chemical and physical structure required for subsequent handling and performance in the battery. Following curing, the plate is dried using any suitable means. The resultant plate, comprising negative active material, is then suitable for use in a lead-acid battery.

For use in an electrochemical capacitor, the carbon blacks of the present invention may be formulated into electrodes by combining them with materials such as activated carbon (or other large porous particles), and a polymer (such as a polymer binder, such as a fluorinated polymer, such as poly(vinylidene fluoride-co-chlorotrifluoroethylene) co-polymer or similar polymers).

In the present invention, the carbon black is, for example, electrically conductive carbon black. It can therefore be used to enhance the conductivity of electrode pastes for lithium ion batteries. The positive electrode of a lithium ion battery typically includes a conductive substrate supporting a mixture (e.g., applied as a paste) having at least an electroactive material, a binder, and a conductive additive, which may include the carbon black of the invention, optionally along with graphite and/or other conductive additives typically used in lithium ion batteries. The electroactive material, such as a lithium transition metal oxide, is capable of receiving and releasing lithium ions. The binder, such as polyvinylidene fluoride, is used to provide mechanical integrity and stability to the electrode. Typically, since the electroactive material and the binder are electrically poorly conducting or insulating, the conductive additive (e.g., graphite and carbon black) is added to enhance the electrical conductivity of the electrode. An electrode is formed by depositing the paste onto an electrically conducting substrate (e.g., an aluminum current collector), followed by removing the solvent. The formed electrode can be incorporated into a lithium-ion battery according to methods known in the art, for example, as described in “Lithium Ion Batteries Fundamentals and Applications”, by Yuping Wu, CRC press, (2015).

An electrode containing the carbon black and optionally other components can be formed, for example, by coating the current collector with a liquid dispersion containing these components as a dispersion formulation. Exemplary liquids include, but are not limited to, organic-based solvents, such as ketone-based solvents like methylethyl ketone or methylisobutyl ketone, and aqueous solvents. Other examples are water and N-methyl pyrollidone (NMP).

Generally, any dispersion formulations, containing a present carbon black, and dispersion preparation and processing, can be used as part of the electrode fabrication. The dispersion formulation can comprise several components: carbon black, binders, dispersing agents, rheology modifiers, solvents, etc. This dispersion formulation can be, for example, in slurry form. The temperature can be controlled during dispersion mixing to from 15 to 45 °C or other ranges. The mixing can be performed via a high shear process, etc., where the mixing device can be a rotor stator, horizontal mill, sonic horn, sonic bath, cowls blade, and the like. Any viscosity of the dispersion can be achieved by choosing the appropriate mass content of particle in the dispersion, and this viscosity is chosen based on the application method of the dispersion. Examples of the coating method include, for example, an extrusion-lamination method, doctor-blade method, gravure-coat method, reverse-coat method, applicator-coat method, and screen-printing method.

The present carbon blacks also can be used in other various energy storage devices, including, for example, the use as a conductive additive to electrodes in batteries, as a catalyst support in fuel cells, and the use in hybrid energy storage devices, which are devices (also known as asymmetric supercapacitors or hybrid battery/supercapacitors) that combine battery electrodes and EDLC electrodes in one cell. For instance, the hybrid lead-carbon energy storage devices employ lead-acid battery positive electrodes and supercapacitor negative electrodes as described in, for example, U.S. Pat. Nos. 6,466,429; 6,628,504; 6,706,079; 7,006,346; and 7,110,242.

Alternatively or in addition, the carbon blacks of the present invention, with or without any of the modifications described above, may also be compounded with thermoplastics to form a masterbatch or compound. Such a compound may be prepared in any manner known to those of ordinary skill in the art for preparing resin compositions. Typically, the components of are admixed with the desired resin, at or above the softening point of the resin, in a conventional mixing apparatus, such as two-rotor mixers, co-kneaders, twin-screw kneaders, Farrell continuous mixers (FCM), long continuous mixers with axial discharge (LCM-AX), and the like. A masterbatch or other thermoplastic composition may include any amount of carbon black, for example, up to 25% carbon black and may also include 0-2 wt % of an antioxidant, e.g., in an amount of 0-2 wt % and/or a processing aid, e.g., in an amount of 0-50 wt %, such as metallic stearates, organic stearates, and fluoroelastomers. Other additives, such as ultraviolet stabilizers, slip stabilizers, lubricants, optical brighteners, antifog and antistatic agents, fillers, pigments, thermally conductive additives, and/or electrically conductive additives, may also be incorporated into a masterbatch or compound. A masterbatch may be combined with additional thermoplastic and optional additives and formed into any product by any method, including but not limited to injection molding, compression molding, extrusion molding from a sheet, film formation, and blow molding. Exemplary polymers that may be combined with the carbon black include but are not limited to thermoplastic polyolefins (TPO), polyethylene (PE), linear low density (LLDPE), low density (LDPE), medium density (MDPE), high density (HDPE), ultra-high molecular weight (UHMWPE), very low density polyethylene (VLDPE), metallocene medium density polyethylene (mLLDPE), polypropylene, copolymers of polypropylene, ethylene propylene rubber (EPR), ethylene propylene diene terpolymers (EPDM), acrylonitrile butadiene styrene (ABS), acrylonitrile EPDM styrene (AES), styrene-butadiene-styrene (SBS), polyoxymethylene (POM), polyamides (PA) polyvinylchloride (PVC), tetraethylene hexapropylene vinylidenefluoride polymers (THV), perfluoroalkoxy polymers (PFA), polyhexafluoropropylene (HFP), polyketones (PK), ethylene vinyl alcohol (EVOH), copolyesters, polyurethanes (PU), thermoplastic polyurethanes, polystyrene (PS), polycarbonate (PC), polybutylene terephthalate (PBT), polyethylene terephthalate (PET), polyphenylene oxide (PPO) and polyphenylene ether (PPE), and mixtures or blends of any of these.

The present invention includes the following aspects/embodiments/features in any order and/or in any combination:
1. A method for producing carbon black comprising:
   introducing a heated gas stream into a carbon black reactor;
   combining at least one feedstock additive with at least one carbon black feedstock to form a feedstock mixture, wherein said at least one feedstock additive comprises strontium or barium or a combination thereof;
   supplying said feedstock mixture to at least one feedstock introduction point of the carbon black reactor,
   combining at least said feedstock mixture through the at least one introduction point to said carbon black reactor with the heated gas stream to form a reaction stream in which carbon black is formed having a nitrogen surface area (N2SA) of from 800 m²/g to 2,500 m²/g, in said carbon black reactor; and
   recovering the carbon black in the reaction stream, wherein the method further comprises operating the carbon black reactor at an overall combustion (OAC) of from 28% to 50%, and the carbon black reactor is configured such that said OAC≤[(1350+N2SA−244*ln (additive ppm+1))/0.003]\hat{ }(1/3.5), and wherein the N2SA is the nitrogen BET surface area, and the “additive ppm” is the total ppm amount (weight ppm) of metallic elements added to the feedstock excluding residual impurities in the feedstock additive.
2. A method for producing carbon black comprising:
   introducing a heated gas stream into a carbon black reactor;
   supplying at least one carbon black feedstock to at least one feedstock introduction point to the carbon black reactor;
   supplying at least one feedstock additive to at least one introduction point to the carbon black reactor, wherein said at least one feedstock additive comprises strontium or barium or a combination thereof;
   combining said at least one carbon black feedstock and said at least one feedstock additive, with the heated gas stream to form a reaction stream in which carbon black is formed having a nitrogen surface area (N2SA) of from 800 m²/g to 2,500 m²/g, in said carbon black reactor; and
   recovering the carbon black in the reaction stream, wherein the method further comprises operating the carbon black reactor at an overall combustion (OAC) of from 28% to 50%, and the carbon black reactor is configured such that said OAC≤[(1350+N2SA−244*ln (additive ppm+1))/0.003]\hat{ }(1/3.5), and wherein the N2SA is nitrogen BET surface area, and the “additive ppm” is the total ppm amount (weight ppm) of metallic elements added to the feedstock excluding residual impurities in the feedstock additive.
3. The method of any preceding or following embodiment/feature/aspect, wherein the N2SA is from 900 m²/g to 2,400 m²/g.
4. The method of any preceding or following embodiment/feature/aspect, wherein said OAC< [(1350+N2SA−244*ln (additive ppm+1))/0.003]\hat{ }(1/3.5).
5. The method of any preceding or following embodiment/feature/aspect, wherein the N2SA is from 850 m²/g to 2,400 m²/g.
6. The method of any preceding or following embodiment/feature/aspect, wherein the OAC is from 33.5% to 46.5%.
7. The method of any preceding or following embodiment/feature/aspect, wherein the OAC is from 33.5% to 46.5% and the N2SA is from 900 m²/g to 2,400 m²/g.
8. The method of any preceding or following embodiment/feature/aspect, wherein the OAC is from 33.5% to 46.5% and the N2SA is from 850 m²/g to 2,400 m²/g.
9. The method of any preceding or following embodiment/feature/aspect, wherein the OAC is from 33.5% to 46.5% and the N2SA is from 1000 m²/g to 2,400 m²/g.
10. The method of any preceding or following embodiment/feature/aspect, wherein said method further comprises injection of oxygen downstream of the feedstock introduction point and upstream of a quench.
11. The method of any preceding or following embodiment/feature/aspect, wherein the at least one feedstock introduction point is two or more feedstock introduction points with at least one feedstock introduction point downstream of at least one other feedstock introduction point.
12. The method of any preceding or following embodiment/feature/aspect, wherein said carbon black reactor comprises a combustion zone, a transition zone, and a reaction zone.
13. The method of any preceding or following embodiment/feature/aspect, wherein said carbon black reactor comprises a combustion zone, a transition zone, a conical entry section, a stepped entry section, a reaction zone, and a quench zone.
14. The method of any preceding or following embodiment/feature/aspect, wherein method is operated by at least controlling the amount of feedstock introduced so that an overall combustion (OAC) is from 33.5% to 46.5%.
15. The method of any preceding or following embodiment/feature/aspect, wherein a Group IA element and/or calcium is introduced, at any point, in an amount of less than 500 ppm as a fraction with respect to the total amount of feedstock.
16. The method of any preceding or following embodiment/feature/aspect, wherein a Group IA element and/or calcium is introduced, at any point, in an amount of less than 100 ppm as a fraction with respect to the total amount of feedstock.
17. The method of any preceding or following embodiment/feature/aspect, wherein a Group IA element and/or calcium is introduced, at any point, in an amount of less than 10 ppm as a fraction with respect to the total amount of feedstock.
18. The method of any preceding or following embodiment/feature/aspect, wherein a Group IA element is introduced, at any point, in an amount of less than 10 ppm based on total feedstock amount and calcium is introduced, at any point, in an amount of less than 10 ppm as a fraction with respect to the total amount of feedstock.
19. The method of any preceding or following embodiment/feature/aspect, wherein no Group IA element is introduced, at any point, and no calcium is introduced, at any point.
20. The method of any preceding or following embodiment/feature/aspect, wherein the at least one feedstock additive is an aqueous liquid containing a strontium salt and/or a barium salt dissolved therein.
21. The method of any preceding or following embodiment/feature/aspect, wherein strontium and/or barium is present in the at least one feedstock additive at the largest weight percentage compared to any metal element present in the feedstock additive.
22. The method of any preceding or following embodiment/feature/aspect, wherein the feedstock additive comprises said strontium and at least one other metal element to form a total amount of metal elements, wherein said strontium comprise from 30 wt % to 99 wt % of the total amount of the metal elements present.
23. The method of any preceding or following embodiment/feature/aspect, wherein the feedstock additive comprises said strontium and at least one other metal element to form a total amount of metal elements, wherein said strontium comprise from 80 wt % to 99 wt % of the total amount of the metal elements present.
24. The method of any preceding or following embodiment/feature/aspect, wherein the at least one other metal element is calcium.
25. The method of any preceding or following embodiment/feature/aspect, wherein the feedstock additive comprises strontium and barium, and the at least one other metal element is calcium.
26. The method of any preceding or following embodiment/feature/aspect, wherein an amount of said feedstock additive is from 50 ppm to 1500 ppm of elemental metal as a fraction with respect to the total amount of feedstock.
27. The method of any preceding or following embodiment/feature/aspect, wherein an amount of said feedstock additive is an amount that results in the carbon black having from 100 ppm to 7,000 ppm of elemental strontium, barium, or both present in the carbon black.
28. The method of any preceding or following embodiment/feature/aspect, wherein the method forms said carbon black having a surface area and a structure and wherein the carbon black reactor is operated at said OAC due, at least in part, to the heated gas stream and a temperature of the reaction stream, and said OAC is at least 4% lower to form said carbon black compared to a method that utilizes only calcium at the same amount for said feedstock additive but is otherwise the same method.
29. A carbon black having a nitrogen BET surface area (N2SA) of from 800 m²/g to 2,500 m²/g and concentration (ppm) of Group IIA elements in the carbon black is less than or equal to 4.3*N2SA−2150, wherein said Group IIA elements at least comprise strontium, barium, or a combination thereof.
30. The carbon black of any preceding or following embodiment/feature/aspect, wherein carbon black has an ash (%) that is ≤0.0012*N2SA−0.24.
31. The carbon black of any preceding or following embodiment/feature/aspect, wherein the N2SA is from 900 m²/g to 2,400 m²/g.
32. The carbon black of any preceding or following embodiment/feature/aspect, wherein the N2SA is from 850 m²/g to 2,400 m²/g.
33. The carbon black of any preceding or following embodiment/feature/aspect, wherein said concentration (ppm) of Group IIA elements in the carbon black is less than 4.3*N2SA−2150.
34. The carbon black of any preceding or following embodiment/feature/aspect, wherein said Group IIA elements are at least 95% strontium, barium, or a combination thereof.
35. The carbon black of any preceding or following embodiment/feature/aspect, wherein said Group IIA elements is at least 30% by weight strontium based on total weight of said Group IIA elements.
36. The carbon black of any preceding or following embodiment/feature/aspect, wherein said Group IIA elements is at least 50% by weight strontium based on total weight of said Group IIA elements.
37. The carbon black of any preceding or following embodiment/feature/aspect, wherein said Group IIA elements is at least 99% by weight strontium based on total weight of said Group IIA elements.
38. The carbon black of any preceding or following embodiment/feature/aspect, wherein said Group IIA elements is at least 30% by weight barium based on total weight of said Group IIA elements.
39. The carbon black of any preceding or following embodiment/feature/aspect, wherein said Group IIA elements is at least 50% by weight barium based on total weight of said Group IIA elements.
40. The carbon black of any preceding or following embodiment/feature/aspect, wherein said Group IIA elements is at least 99% by weight barium based on total weight of said Group IIA elements.
41. The carbon black of any preceding or following embodiment/feature/aspect, wherein said carbon black has a concentration of Group IA elements in the carbon black of less than 100 ppm.
42. The carbon black of any preceding or following embodiment/feature/aspect, wherein said carbon black has a concentration of Group IA elements in the carbon black of less than 50 ppm.
43. The carbon black of any preceding or following embodiment/feature/aspect, wherein said carbon black has a concentration of Group IA elements in the carbon black of less than 20 ppm.
44. The carbon black of any preceding or following embodiment/feature/aspect, wherein said carbon black has a concentration of Group IA elements in the carbon black of less than 15 ppm.
45. The carbon black of any preceding or following embodiment/feature/aspect, wherein said carbon black has a concentration of strontium and/or barium from 100 to 7000 ppm.
46. The carbon black of any preceding or following embodiment/feature/aspect, wherein said carbon black has a concentration of strontium and/or barium of at least 200 ppm.

The present invention can include any combination of these various features or embodiments above and/or below as set forth in sentences and/or paragraphs. Any combination of disclosed features herein is considered part of the present invention and no limitation is intended with respect to combinable features.

The present invention will be further clarified by the following examples, which are intended to be only exemplary of the present invention. Unless indicated otherwise, all amounts, percentages, ratios and the like used herein are by weight.

### EXAMPLES

### Example 1

### Preparation of Carbon Black

Carbon blacks were prepared in a reactor as described above and shown in FIG. 2, utilizing a liquid feedstock having properties set forth in Table 1 and reactor conditions and geometry set forth in Table 2. Natural gas was employed as the fuel for the combustion reaction. An aqueous solution of strontium or barium or calcium (comparative) or strontium with calcium was used as the feedstock additive, and was mixed with a liquid feedstock prior to injection into the reactor in zone 3 (with reference made to FIG. 2). Strontium, barium, and calcium were all used as aqueous solutions of the metal acetate. The reaction was quenched with water purified by reverse osmosis.

TABLE 1
Feedstock Properties

| Feedstock Type | FS-A |
|---|---|
| Hydrogen (wt %) | 7.60 |
| Carbon (wt %) | 91.00 |
| Sulfur (wt %) | 0.71 |
| Nitrogen (wt %) | 0.30 |
| Oxygen (wt %) | 0.39 |
| Specific Gravity at 15.5 °C [ASTM 4052] | 1.0910 |

TABLE 2
Reactor Geometry and Fixed Operating Conditions

| Parameters | |
|---|---|
| D-1 (m) | 0.18 |
| D-2 (m) | 0.13 |
| D-3 (m) | NA |
| D-4 (m) | NA |
| D-5 (m) | 0.69 |
| D-6 (m) | NA |
| D-7 (m) | NA |
| D-8 (m) | 0.91 |
| D-9 (m) | 0.69 |
| L-1 (m) | 0.61 |
| L-2 (m) | 0.30 |
| L-3 (m) | NA |
| L-4 (m) | NA |
| L-5 (m) | 0.38 |
| L-6 (m) | NA |
| L-7 (m) | NA |
| L-8 (m) | 9.45 |
| L-9 (m) | 7.87 |
| A (m) | NA |
| B (m) | NA |
| Q (m) | 15.3 |
| Combustion Air (nm³/h)* | 2400 |
| Combustion Air Preheat (K) | 798 |
| Burner Natural Gas (nm³/h)* | 179 |
| No. Feedstock Injection Orifices | 6 |
| Primary Combustion (%)** | 120 |

*nm³ refers to normal cubic meters, where “normal” refers to the gas volume corrected to 25 °C and 1 atm pressure.
**Primary combustion is defined as the percentage of oxygen added to the combustion zone 1 compared to the total amount of oxygen required to stoichiometrically react with the natural gas added to combustion zone 1.

TABLE 3
Operating Conditions for Calcium Addition Examples

| | Carbon Black Example | | | |
|---|---|---|---|---|
| Parameter | 1 | 2 | 3 | 4 |
| Feedstock Injection Orifice Diameter (cm) | 0.071 | 0.071 | 0.071 | 0.097 |
| Feedstock Rate (kg/h) | 390 | 425 | 492 | 563 |
| Feedstock Temperature (K) | 446 | 445 | 446 | 455 |
| Ca²⁺ Concentration in Feedstock (ppm) | 1500 | 1500 | 1500 | 1000 |
| Sr²⁺ Concentration in Feedstock (ppm) | 0 | 0 | 0 | 0 |
| Ba²⁺ Concentration in Feedstock (ppm) | 0 | 0 | 0 | 0 |
| Overall Combustion (%)*** | 42.5 | 40.0 | 36.0 | 32.5 |
| Quench Water Rate (kg/h) | 622 | 718 | 783 | 927 |
| N2SA (m2/g) | 1703.1 | 1520.1 | 1094.7 | 804.5 |
| Ca²⁺ concentration in black (ppm) | 5695 | 4717 | 3600 | 2093 |
| Ash concentration in black (%) | 2.56 | 1.98 | 1.6 | 0.88 |

***Overall combustion is defined as the percentage of oxygen added to the entire reactor compared to the total amount of oxygen required to stoichiometrically react with all the fuel streams added to the entire reactor.

TABLE 4
Operating Conditions for Calcium/Strontium Addition Examples

| | Carbon Black Example | |
|---|---|---|
| Parameter | 5 | 6 |
| Feedstock Injection Orifice Diameter (cm) | 0.071 | 0.071 |
| Feedstock Rate (kg/h) | 390 | 390 |
| Feedstock Temperature (K) | 452 | 451 |
| Ca²⁺ Concentration in Feedstock (ppm) | 350 | 70 |
| Sr²⁺ Concentration in Feedstock (ppm) | 350 | 630 |
| Ba²⁺ Concentration in Feedstock (ppm) | 0 | 0 |
| Overall Combustion (%)*** | 42.5 | 42.5 |
| Quench Water Rate (kg/h) | 644 | 676 |
| N2SA (m2/g) | 2223.7 | 2236.1 |
| Ca²⁺ concentration in black (ppm) | 2601 | 826 |
| Sr²⁺ concentration in black (ppm) | 2331 | 4526 |
| Ash concentration in black (%) | 1.6 | 1.48 |

***Overall combustion is defined as the percentage of oxygen added to the entire reactor compared to the total amount of oxygen required to stoichiometrically react with all the fuel streams added to the entire reactor.

TABLE 5
Operating Conditions for Strontium Addition Examples

| | Carbon Black Example | | | | | |
|---|---|---|---|---|---|---|
| Parameter | 7 | 8 | 9 | 10 | 11 | 12 |
| Feedstock Injection Orifice | 0.071 | 0.071 | 0.071 | 0.071 | 0.071 | 0.071 |
| Diameter (cm) | | | | | | |
| Feedstock Rate (kg/h) | 390 | 425 | 492 | 390 | 425 | 492 |
| Feedstock Temperature (K) | 454 | 407 | 405 | 413 | 404 | 407 |
| Ca²⁺ Concentration in Feedstock | 0 | 0 | 0 | 0 | 0 | 0 |
| (ppm) | | | | | | |
| Sr²⁺ Concentration in Feedstock | 700 | 700 | 700 | 250 | 250 | 250 |
| (ppm) | | | | | | |
| Ba²⁺ Concentration in Feedstock | 0 | 0 | 0 | 0 | 0 | 0 |
| (ppm) | | | | | | |
| Overall Combustion (%)*** | 42.5 | 40 | 36 | 42.5 | 40 | 36 |
| Quench Water Rate (kg/h) | 600 | 682 | 716 | 675 | 724 | 900 |
| N2SA (m2/g) | 2259.9 | 1933.4 | 1251.7 | 1831.4 | 1509.4 | 1019.4 |
| Sr²⁺ concentration in black (ppm) | 6095 | 3280 | 2032 | 1391 | 1020 | 684 |
| Ash concentration in black (%) | 1.81 | 0.35 | 0.3 | 0.74 | 0.16 | 0.45 |

***Overall combustion is defined as the percentage of oxygen added to the entire reactor compared to the total amount of oxygen required to stoichiometrically react with all the fuel streams added to the entire reactor.

TABLE 6
Operating Conditions for Barium Addition Examples

| | Carbon Black Example | | | | | | |
|---|---|---|---|---|---|---|---|
| Parameter | 13 | 14 | 15 | 16 | 17 | 18 | 19 |
| Feedstock Injection | 0.071 | 0.071 | 0.071 | 0.071 | 0.071 | 0.071 | 0.071 |
| Orifice Diameter (cm) | | | | | | | |
| Feedstock Rate (kg/h) | 390 | 425 | 492 | 390 | 425 | 492 | 492 |
| Feedstock Temperature | 407 | 405 | 404 | 409 | 407 | 405 | 404 |
| (K) | | | | | | | |
| Ca²⁺ Concentration in | 0 | 0 | 0 | 0 | 0 | 0 | 0 |
| Feedstock (ppm) | | | | | | | |
| Sr²⁺ Concentration in | 0 | 0 | 0 | 0 | 0 | 0 | 0 |
| Feedstock (ppm) | | | | | | | |
| Ba²⁺ Concentration in | 700 | 700 | 700 | 250 | 250 | 250 | 1000 |
| Feedstock (ppm) | | | | | | | |
| Overall Combustion | 42.5 | 40 | 36 | 42.5 | 40 | 36 | 36 |
| (%)*** | | | | | | | |
| Quench Water Rate (kg/h) | 633 | 703 | 690 | 740 | 817 | 886 | 721 |
| N2SA (m2/g) | 2086.7 | 1803 | 1091 | 1876.4 | 1483.1 | 896.1 | 1195.8 |
| Ba²⁺ concentration in | 6353 | 3087 | 1837 | 1658 | 929 | 645 | 2743 |
| black (ppm) | | | | | | | |
| Ash concentration in black | 1.25 | 0.32 | 0.25 | 0.6 | 0.17 | 0.3 | 0.63 |
| (%) | | | | | | | |

***Overall combustion is defined as the percentage of oxygen added to the entire reactor compared to the total amount of oxygen required to stoichiometrically react with all the fuel streams added to the entire reactor.

Tables 3, 4, 5, and 6 indicate the surface area (BET surface area measured as described above) and the calcium, strontium, and barium content of the carbon blacks. The amount of these Group IIA elements present was measured by inductively coupled plasma as follows. A 5-10 mg sample was ashed using a muffle furnace as described in ASTM D1506. The resulting ash was combined with 2 mL concentrated HCl, 0.5 mL concentrated HNO₃, and a small amount of reagent grade water. The sample was then brought to 50 mL with yttrium as an internal standard and reagent grade water and analyzed using an Agilent ICP-OES Model 5110 spectrometer.

The results from Tables 3, 4, 5, and 6 are plotted in FIGS. 1A-B, 3, and 4. FIGS. 1A and 1B are graphs plotting OAC (%) versus nitrogen surface area. As both OAC and feedstock additive concentration both influence surface area, each additive concentration used in the feedstock is plotted with its own symbol (squares-250 ppm (FIG. 1A), triangles-700 ppm (FIG. 1B), circles-1000 ppm (FIG. 1A), diamonds-1500 ppm (FIG. 1B)). The striped symbols indicate curves of the equation OAC=[(1350+N2SA−244*ln (additive ppm+1))/0.003]\hat{ }(1/3.5) for each additive concentration. It can be seen from the graph that carbon blacks produced with Sr (open symbols), Ba (closed symbols), and Sr—Ca blends (stippled triangles) consistently satisfy the equation OAC≤[(1350+N2SA−244*ln (additive ppm+1))/0.003]\hat{ }(1/3.5) and are situated on or below their corresponding curves (depending on additive concentration). In contrast, carbon blacks produced with only Ca (stippled circles and diamonds) do not satisfy this equation and are situated above their corresponding curves (depending on additive concentration).

FIG. 3 is a graph showing the total Group IIA element concentration in the carbon black with respect to surface area. It can be seen from the graph that carbon blacks produced with Sr or Ba (including Sr—Ca blends) consistently exhibit a Group IIA concentration (ppm) in CB less than 4.3*N2SA−2150, while carbon blacks produced with only Ca have higher amounts of Group IIA elements. This reduced amount of Group IIA elements correlates with lower ash levels that may enhance carbon black conductivity and enhance the appearance and processability of thermoplastics containing such carbon blacks. FIG. 4 is a graph confirming the reduced ash concentration. It can be seen from the graph that carbon blacks produced with Sr or Ba (including Sr—Ca blends) consistently exhibit an ash concentration (%) in CB less than 0.0012*N2SA−0.24, while carbon blacks produced with only Ca have higher ash levels.

### Example 2

Carbon blacks are prepared in a reactor as described above and shown in FIG. 2, utilizing a liquid feedstock having properties set forth in Table 1 and reactor conditions and geometry set forth in Table 2. Natural gas is employed as the fuel for the combustion reaction. An aqueous solution of strontium or calcium (comparative) with potassium (as potassium acetate) is used as the feedstock additive, and is mixed with a liquid feedstock prior to injection into the reactor in zone 3 (with reference made to FIG. 2). The reaction is quenched with water purified by reverse osmosis.

TABLE 7
Operating Conditions for Potassium Addition Examples

| | Carbon Black Example | |
|---|---|---|
| Parameter | 20 | 21 |
| Feedstock Injection Orifice Diameter (cm) | 0.097 | 0.071 |
| Feedstock Rate (kg/h) | 563 | 492 |
| Feedstock Temperature (K) | 455 | 407 |
| Ca²⁺ Concentration in Feedstock (ppm) | 1000 | 0 |
| Sr²⁺ Concentration in Feedstock (ppm) | 0 | 250 |
| K¹⁺ Concentration in Feedstock (ppm) | 10 | 10 |
| Overall Combustion (%)*** | 32.5 | 36 |
| Quench Water Rate (kg/h) | 927 | 900 |

***Overall combustion is defined as the percentage of oxygen added to the entire reactor compared to the total amount of oxygen required to stoichiometrically react with all the fuel streams added to the entire reactor.

It is expected that varying the amount of potassium in the feedstock will have a negligible effect on the surface area of the carbon black, especially in comparison to the effect of strontium addition.

### Example 3

Carbon blacks are prepared in a reactor as described above and shown in FIG. 2, utilizing a liquid feedstock having properties set forth in Table 1 and reactor conditions and geometry set forth in Table 2. Natural gas is employed as the fuel for the combustion reaction. An aqueous solution of strontium acetate and barium acetate is used as the feedstock additive, and is mixed with a liquid feedstock prior to injection into the reactor in zone 3 (with reference made to FIG. 2). The reaction is quenched with water purified by reverse osmosis.

TABLE 8
Operating Conditions for Strontium/Barium
Blend Addition Examples

| | Carbon |
|---|---|
| | Black Example |
| Parameter | 22 |
| Feedstock Injection Orifice Diameter (cm) | 0.071 |
| Feedstock Rate (kg/h) | 492 |
| Feedstock Temperature (K) | 405 |
| Ca²⁺ Concentration in Feedstock (ppm) | 0 |
| Sr²⁺ Concentration in Feedstock (ppm) | 350 |
| Ba²⁺ Concentration in Feedstock (ppm) | 350 |
| Overall Combustion (%)*** | 36 |
| Quench Water Rate (kg/h) | 716 |

***Overall combustion is defined as the percentage of oxygen added to the entire reactor compared to the total amount of oxygen required to stoichiometrically react with all the fuel streams added to the entire reactor.

It is expected that the use of strontium and barium in combination at an overall combustion rate of 36% will result in a carbon black with a surface area satisfying the equation equation OAC≤[(1350+N2SA−244*ln (additive ppm+1)/0.003]\hat{ }(1/3.5).

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. It is further understood that for any range provided herein, the numerical ranges can be “about” these ranges, and vice versa, where a range is provided using “about” ranges, these ranges can be precisely the number ranges provided. Any combination of embodiments, and/or ingredients and/or components and/or properties recited herein can be made herein and is considered part of the present invention

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A method for producing carbon black comprising:
introducing a heated gas stream into a carbon black reactor;
combining at least one feedstock additive with at least one carbon black feedstock to form a feedstock mixture, wherein said at least one feedstock additive comprises strontium or barium or a combination thereof;
supplying said feedstock mixture to at least one feedstock introduction point of the carbon black reactor,
combining at least said feedstock mixture through the at least one introduction point to said carbon black reactor with the heated gas stream to form a reaction stream in which carbon black is formed having a nitrogen surface area (N2SA) of from 800 m²/g to 2,500 m²/g, in said carbon black reactor; and
recovering the carbon black in the reaction stream, wherein the method further comprises operating the carbon black reactor at an overall combustion (OAC) of from 28% to 50%, and the carbon black reactor is configured such that said OAC≤[(1350+N2SA−244*ln (additive ppm+1))/0.003]\hat{ }(1/3.5), and wherein the N2SA is the nitrogen BET surface area, and the “additive ppm” is the total ppm amount (weight ppm) of metallic elements added to the feedstock excluding residual impurities in the feedstock additive.

2. A method for producing carbon black comprising:
introducing a heated gas stream into a carbon black reactor;
supplying at least one carbon black feedstock to at least one feedstock introduction point to the carbon black reactor;
supplying at least one feedstock additive to at least one introduction point to the carbon black reactor, wherein said at least one feedstock additive comprises strontium or barium or a combination thereof;
combining said at least one carbon black feedstock and said at least one feedstock additive, with the heated gas stream to form a reaction stream in which carbon black is formed having a nitrogen surface area (N2SA) of from 800 m²/g to 2,500 m²/g, in said carbon black reactor; and
recovering the carbon black in the reaction stream, wherein the method further comprises operating the carbon black reactor at an overall combustion (OAC) of from 28% to 50%, and the carbon black reactor is configured such that said OAC≤[(1350+N2SA−244*ln (additive ppm+1))/0.003]\hat{ }(1/3.5), and wherein the N2SA is the nitrogen BET surface area, and the “additive ppm” is the total ppm amount (weight ppm) of metallic elements added to the feedstock excluding residual impurities in the feedstock additive.

3. (canceled)

4. (canceled)

5. (canceled)

6. (canceled)

7. (canceled)

8. (canceled)

9. (canceled)

10. The method of claim 1, wherein said method further comprises injection of oxygen downstream of the feedstock introduction point and upstream of a quench.

11. The method of claim 1, wherein the at least one feedstock introduction point is two or more feedstock introduction points with at least one feedstock introduction point downstream of at least one other feedstock introduction point.

12. (canceled)

13. (canceled)

14. (canceled)

15. The method of claim 1, wherein a Group IA element and/or calcium is introduced, at any point, in an amount of less than 500 ppm as a fraction with respect to the total amount of feedstock.

16. (canceled)

17. (canceled)

18. (canceled)

19. (canceled)

20. (canceled)

21. (canceled)

22. (canceled)

23. (canceled)

24. (canceled)

25. (canceled)

26. The method of claim 1, wherein an amount of said feedstock additive is from 50 ppm to 1500 ppm of elemental metal as a fraction with respect to the total amount of feedstock.

27. The method of claim 1, wherein an amount of said feedstock additive is an amount that results in the carbon black having from 100 ppm to 7,000 ppm of elemental strontium, barium, or both present in the carbon black.

28. The method of claim 1, wherein the method forms said carbon black having a surface area and a structure and wherein the carbon black reactor is operated at said OAC due, at least in part, to the heated gas stream and a temperature of the reaction stream, and said OAC is at least 4% lower to form said carbon black compared to a method that utilizes only calcium at the same amount for said feedstock additive but is otherwise the same method.

29. A carbon black having a nitrogen BET surface area (N2SA) of from 800 m²/g to 2,500 m²/g and concentration (ppm) of Group IIA elements in the carbon black is at least 200 ppm and less than or equal to 4.3*N2SA−2150, wherein said Group IIA elements at least comprise strontium, barium, or a combination thereof.

30. The carbon black of claim 29, wherein carbon black has an ash (%) that is ≤0.0012*N2SA−0.24.

31. (canceled)

32. (canceled)

33. (canceled)

34. The carbon black of claim 29, wherein said Group IIA elements are at least 95% strontium, barium, or a combination thereof.

35. The carbon black of claim 29, wherein said Group IIA elements is at least 30% by weight strontium based on total weight of said Group IIA elements.

36. (canceled)

37. (canceled)

38. (canceled)

39. (canceled)

40. (canceled)

41. The carbon black of claim 29, wherein said carbon black has a concentration of Group IA elements in the carbon black of less than 100 ppm.

42. (canceled)

43. (canceled)

44. (canceled)

45. (canceled)

46. (canceled)

47. The method of claim 2, wherein said method further comprises injection of oxygen downstream of the feedstock introduction point and upstream of a quench.

48. The method of claim 2, wherein the at least one feedstock introduction point is two or more feedstock introduction points with at least one feedstock introduction point downstream of at least one other feedstock introduction point.

49. The method of claim 2, wherein a Group IA element and/or calcium is introduced, at any point, in an amount of less than 500 ppm as a fraction with respect to the total amount of feedstock.

50. The method of claim 2, wherein an amount of said feedstock additive is from 50 ppm to 1500 ppm of elemental metal as a fraction with respect to the total amount of feedstock.

51. The method of claim 2, wherein an amount of said feedstock additive is an amount that results in the carbon black having from 100 ppm to 7,000 ppm of elemental strontium, barium, or both present in the carbon black.

52. The method of claim 2, wherein the method forms said carbon black having a surface area and a structure and wherein the carbon black reactor is operated at said OAC due, at least in part, to the heated gas stream and a temperature of the reaction stream, and said OAC is at least 4% lower to form said carbon black compared to a method that utilizes only calcium at the same amount for said feedstock additive but is otherwise the same method.
